(19) United States
(12) Patent Application Publication
(10) Pub. No.: US 2007/0078986 A1
(43) Pub. Date: Apr. 5, 2007

(54) Techniques for reducing session set-up for real-time communications over a network

(75) Inventors: Randall Ethier, Burke, VA (US); Michael Philip Hammer, Reston, VA (US)

Correspondence Address: EVANS & MOLINELLI, PLLC, U.S. POST OFFICE BOX 7024, FAIRFAX STATION, VA, 22039, US

(73) Assignee: Cisco Technology, Inc.

(21) Appl. No.: 11/224,817

(22) Filed: Sep. 13, 2005

(51) Int. Cl. G06F 15/16

(52) U.S. Cl. 709/227

(57) ABSTRACT

Techniques for reducing session set up for real-time communications over a network include determining whether conditions are satisfied for storing session data for a first actual or prospective session and receiving the session data to be stored. The session data indicates multiple properties for real-time communications between a local node and a remote end node connected to a network. If these conditions are satisfied, then the session data is stored. If it is determined that a second session is to be established between the local node and the remote end node, then multiple properties of the second session are determined based on the stored session data. The second session is established using the stored session data instead of at least some negotiations. These techniques reduce the perceived delay from start of setup to commencement of real-time communications, or reduce the resources consumed by the end nodes and network, or both.

### BACKGROUND OF THE INVENTION

1. Field of the Invention

The present invention relates to session-oriented network communications, and, in particular, to techniques for reducing elapsed time and consumption of resources during the establishment of a session for real-time communications between end nodes on a network.

2. Description of the Related Art

Networks of special purpose devices and general purpose computer systems connected by external communication links are well known and widely used in commerce. The networks often include one or more network devices that facilitate the passage of information between other devices. A network node is a network device, or special purpose device, or general-purpose computer system connected by the communication links. An “end node” is a network node that is configured to originate or terminate communications over the network. An “intermediate network node” facilitates the passage of data between end nodes.

Information is exchanged between network nodes according to one or more of many well known, new or still developing protocols. In this context, a “protocol” consists of a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information, among others.

Telephone networks rely on circuit-switched network devices that establish a dedicated line between telephone end nodes for the duration of a telephone call. Signals are sent between network nodes to set up a circuit to service a call, to maintain the circuit during the call, and to free up (also called “tear down”) the circuit at the end of the call. Between set up and tear down, voice or other data are transmitted over the circuit. Such telephone networks have been used traditionally to support delay sensitive communications, called real-time communications, such as voice. As demands have risen for higher throughput real-time communications such as video, the telephone networks have become heavily burdened.

A modern development has been to rely on lower cost packet switched networks (PSNs) to support real-time communications, including live voice, high throughput live video, and other substantively simultaneously shared application data. For example, the Session Initiation Protocol (SIP) has been developed to use the Internet Protocol (IP) on PSNs to set up and support general real-time communications using any kind of media or shared application data.

With recent technological advances, various specialized and mobile devices have participated as end nodes in PSN network communications. Such devices include, but are not limited to, wireless telephones, personal digital assistants (PDAs), electronic notebooks, household appliances, devices for human interface, and other devices capable of initiating or receiving voice, video or other data communicated over a network.

Network communications with such devices are often routed through a server called a Proxy Server or, between heterogeneous networks, a Service Gateway (SG). The SG performs various functions for the device, such as reformatting resources for the special characteristics of the device. Some services are subscriber aware and determine the subscriber associated with a device by monitoring messages exchanged between the device and an Authentication, Authorization, and Accounting (AAA) server. Various subscriber-aware services are known, such as filtering data by content, filtering by source (e.g., firewall services), data compression for faster transfers, encryption, guaranteeing a minimum quality of service, and presence.

The client-server model of computer process interaction is widely known and widely used on networks. According to the client-server model, a client process sends a message including a request to a server process, and the server process responds by providing a service. The server process may also return a message with a response to the client process. Often the client process and server process execute on different processing devices, called hosts, and communicate via a network using one or more protocols for network communications. Network nodes are often hosts for client and server processes. The term “server” is conventionally used to refer to the process that provides the service, or the host computer on which the process that provides the service operates. Similarly, the term “client” is conventionally used to refer to the process that makes the request, or the host computer on which the process that makes the request operates. As used herein, the terms “client” and “server” refer to the processes, rather than the host devices, unless otherwise clear from the context. In addition, the server process can be broken up to run as multiple processes on multiple hosts (sometimes called tiers) for reasons that include reliability, scalability, and redundancy.

Real-time communications over PSNs are supported by protocols that set up a persistent session between end nodes, maintain the session, and tear down the session upon completion of the communication. All packets communicated between the end nodes during the session use the same protocols, data coding, encryption and other properties established for the session during setup. With the wide array of devices and evolving services, the setup process is becoming ever more complex, resource hungry and time consuming. For example, setting up an audio-video communication between two desktop computers as end nodes at different sites separated by a wide area IP network, such as the public Internet, can involve a large number of messages between the end nodes and intermediate nodes, engaging several servers, and consuming substantial network bandwidth, processing power at both end nodes, and travel time before the first image and sound is transmitted from one end node to the other. The consumption of these resources not only prevents the involved network nodes from performing other work, but is perceived by the users as a substantial delay of many seconds from requesting the session to beginning the real-time communications. The consumption of resources and perceived delays are likely to worsen as more devices, media and service become available, even if those new elements are not used in the real-time communications eventually established.

In some approaches, faster hardware and more efficient software and protocols are used to decrease session setup delay. A disadvantage of relying on faster hardware is that many networks are already in place. Replacing deployed hardware is a slow process that takes many years and large investments of capital. Software improvements have not yet been able to keep pace with the increasing consumption of resources.

In some approaches, assigning a higher level of quality of service (QoS) to signaling may also help reduce session setup delay. While QoS level increases allows more data to be transmitted per second between any two nodes, it can not reduce the round-trip travel time (RTT) that increases as more messages are exchanged with more servers located around the network to obtain more services during setup of the real-time communications session. RTT delay is a result of geographic distance bounded by the speed of light. Even with the fastest hardware, software, and network trans-node delays, further reductions can be achieved only through reduction of the number of round trips.

Based on the foregoing there is a clear need to reduce the amount of data and number of messages exchanged with servers, or to reduce the perceived delay, or both, during session setup for real-time communications over a PSN.

The past approaches described in this section could be pursued, but are not necessarily approaches that have been previously conceived or pursued. Therefore, unless otherwise indicated herein, the approaches described in this section are not to be considered prior art to the claims in this application merely due to the presence of these approaches in this background section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram that illustrates a PSN network for real-time communications, according to an embodiment;

FIG. 2 is a block diagram that illustrates a data structure for storing multiple session profiles, according to an embodiment;

FIG. 3 is a flow diagram that illustrates at a high level a method at an end node for reducing session setup, according to an embodiment;

FIG. 4A is a flow diagram that illustrates details of a step of the method of FIG. 3, according to an embodiment;

FIG. 4B is a flow diagram that illustrates details of a different step of the method of FIG. 3, according to an embodiment;

FIG. 5A, FIG. 5B, FIG. 5C are sequential time sequence diagrams that illustrate example network traffic to set up a real-time communication session using conventional methods;

FIG. 6 is a time sequence diagram that illustrates example network traffic to set up a real-time communication session; according to an embodiment; and

FIG. 7 is a block diagram that illustrates a computer system upon which an embodiment of the invention may be implemented.

### DETAILED DESCRIPTION

Techniques are described for reducing session setup for real-time communications. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

For purposes of illustration, embodiments of the invention are described in the context of session setup involving non-symmetric network address translation (NAT), authentication, encryption based on Public Key Infrastructure (PKI) certificates, and media negotiation using SIP encapsulated in IP payloads between general purpose computers on IP-based local networks; but the invention is not limited to this context. In other contexts, embodiments of the invention involve other end nodes, such as personal digital assistants (PDAs); on other local networks, such as Ethernet or wireless access points; using other network services, such as wireless application protocol (WAP) gateways, symmetric NATs, firewalls, and other security services; and other protocols, such as Media Gateway Control Protocol (MGCP) and International Telephony Union (ITU) SS7 or H.323. There are too many such alternative combinations to list them all here.

In the illustrated embodiments, session data that can be used between a local end node and a particular remote end node, or group of end nodes, is determined at a convenient time before a session is actually requested by a local user of the local end node; and that session data is stored for subsequent use. To increase the likelihood that the stored session data is useful to the local user, the particular remote end node is selected based on its association with a previous session or a remote user on a particular list maintained by the local user, such as a buddy list for instant messaging service, or an enterprise call plan. In various embodiments, the convenient time is the time of the previous session, if any, or some time when a remote user on the particular list first becomes available, or when end node and network resources have sufficient capacity, or some combination. In some embodiments, local node resources are preserved by limiting the amount of storage allocated to storing session data, or number of remote end nodes for which session data is stored, or time during which session data is held in storage. Stored session data not within these limits is deleted in these embodiments. In some embodiments the limits prevent session data from being stored in the first place.

1.0 Network Overview

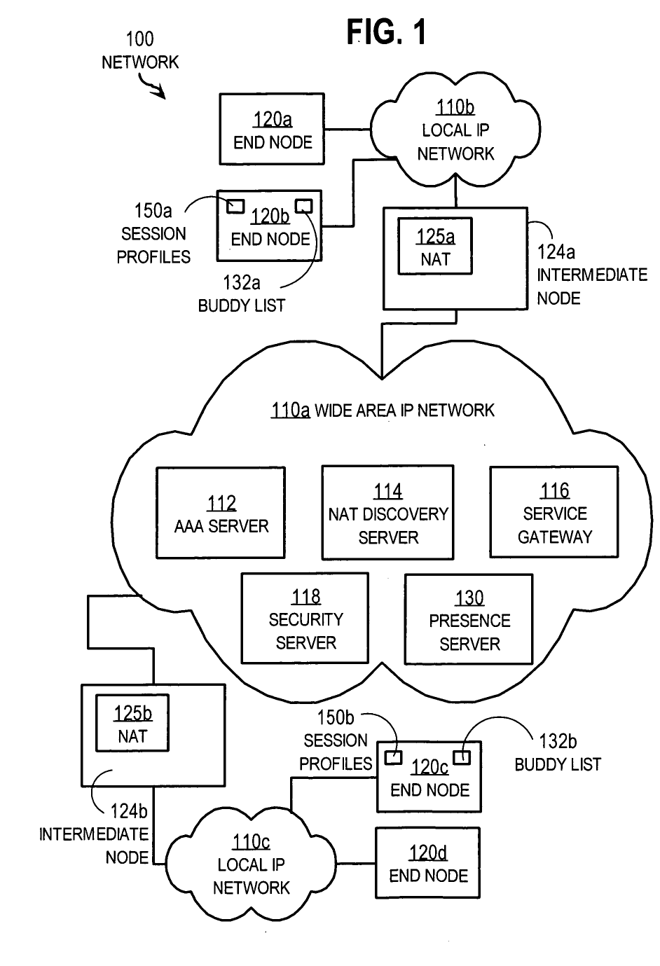

FIG. 1 is a block diagram that illustrates a PSN network 100 for supporting real-time communications, according to an embodiment. The network 100 includes a wide area IP network 110a, such as the public Internet, and two local IP networks 110b, 110c (collectively referenced hereinafter as IP networks 110). End nodes 120a, 120b are connected to local IP network 110b; and end nodes 120c, 120d are connected to local IP network 110c. End nodes 120a, 120b, 120c, 120d are collectively referenced hereinafter as end nodes 120. Although two local IP networks 110b, 110c with four end nodes 120, are shown for purposes of illustration, in other embodiments network 100 includes more or fewer local IP networks and end nodes 120. Local IP networks 110b, 110c are connected to wide area IP network 110a through intermediate network nodes 124a, 124b, respectively (collectively referenced hereinafter as-intermediate nodes 124).

Wide area IP networks include servers for various services involved in setting up sessions between end nodes. In the illustrated embodiment, wide area IP network 110a includes an AAA server 112, a network address translator (NAT) discovery server 114, a service gateway 116, a security server 118, and a presence server 130. Although a single server of each type is shown in FIG. 1 for purposes of illustration, in other embodiments the wide area IP network 110a includes more or fewer of each server type, as well as other servers, not depicted.

The AAA server 112 provides authentication, authorization and accounting services for users of end nodes connected to wide area IP network 110a. AAA servers are widely known in the art and include Remote Authentication for Dial In User Service (RADIUS) servers, Diameter servers, and Terminal Access Controller Access Control System (TACACS) servers. In some embodiments, one or more messages are exchanged with the AAA server 112 during session setup.

The NAT discovery server 114 is described in more detail below. In some embodiments, one or more messages are exchanged with the NAT discovery server 114 during session setup.

The service gateway 116 is a server that provides services for particular kinds of end nodes, including end nodes that are not on IP networks. The service gateway 116 performs various functions for the end node, such as reformatting resources for the special characteristics of the end node, and to serve as a proxy for SIP user agents. In some embodiments, one or more messages are exchanged with the service gateway 116 during session setup.

A security server 118 provides various security and encryption services. For example, a PKI server issues certificates for the PKI; and a KERBEROS server provides information for a shared secret between two end nodes, which can be used for efficient encryption and decryption. In some embodiments, one or more messages are exchanged with the security server 118 during session setup.

The presence server 130 provides information about which subscribers are currently available and reachable from network 110a. Data indicating the presence of a user on a network including a wireless network, a large area network, the Internet or a cellular telephone network is called herein “presence data.” Presence data is used in several extant and emerging applications. For example, in instant messaging applications, such as AOL Instant Messenger (AIM) from America Online of Dulles, Va. and PresenceWorks of PresenceWorks, Inc in Alexandria Va., presence data indicates the instantaneous knowledge that someone is available online and reachable via instant messaging. In this case presence server 130 stores for each particular subscriber a buddy list of other subscribers, collects presence data about subscribers, and notifies the particular subscriber of any change in the presence of the other subscribers on the particular subscriber's buddy list. As stated above, in some embodiments the service provided by a server is distributed among several hosts. In peer-to-peer presence systems, the presence data is distributed among hosts of subscribers. In FIG. 1 buddy list data structures 132a, 132b (collectively referenced hereinafter as buddy list 132) are depicted on end nodes 120b, 120c, respectively. In some embodiments, one or more messages are exchanged with the presence server 130 during session setup.

IP addresses on local IP networks 110b, 110c are assigned independently, and therefore can reuse the same IP address for different nodes on different local IP networks. An IPv4 address is four octets (an octet is eight binary digits), usually represented as four decimal numbers from 0 through 255 separated by periods. For example, end nodes 120b and end node 120c can have the same local IP address 192.0.0.1. Therefore each intermediate node 124a, 124b connecting a local IP network 110b, 110c to wide area IP network 110a includes a Network Address Translator (NAT) process, 125a, 125b, respectively (collectively referenced hereinafter as NAT 125). The NAT 125 maps the internal local IP address of end nodes on its local IP network to an external IP address and Transport Control Protocol (TCP) or User Datagram Protocol (UDP) port number. The term NAT is here used to represent both NAT performing only IP address translation and NATP performing both IP and port translation.

There are different NAT designs (called NAT architectures) that do this mapping differently. A full cone NAT maps active sessions involving a local IP address and port to a specific external IP address and port. Such sessions can be initiated by either an internal end node on the local IP network (e.g., network 110b) or an external end node on a different network (e.g., networks 110a, 110c). A restricted cone NAT or port-restricted cone NAT requires external packets directed to an internal end node to specify a source IP address or port that has already been used by at least one internal end node. Such a NAT design only allows sessions to be initiated by an end node on its local IP network. A symmetric NAT is even more restrictive and assigns a unique external port to every session initiated by an internal end node to every external end node. External end nodes can only initiate a session with a particular internal end node if the source IP address and port number of the external end node were previously used by that particular internal end node.

In general, an internal end node does not know the external IP address and port assigned by the NAT 125. Thus during session setup, the internal end node does not know what IP address and port to use so that the external end node can reach the internal end node. The NAT discovery server 114 is used so that an internal end node can discover its external IP address and port. NAT discovery servers are well known in the art and include: the Simple Traversal of UDP through NATs (STUN); Traversal Using Relay NAT (TURN); and Interactive Connectivity Establishment (ICE).

For a session to be initiated using SIP, a user agent client (UAC) process on one end node attempts to contact a user agent server (UAS) on the other end node. After contact, the UAC and UAS exchange messages about the type of real-time media to be communicated. A UAC and UAS (not shown) execute on all end nodes that engage in SIP sessions.

SIP and other protocols mentioned above are described in more detail in the requests for comments (RFCs) documents RFC3261, RFC3264, RFC3856, RFC3581, RFC3665, of the Internet Engineering Task Force (IETF) website at domain ietf.com in directory /rfc.html, the contents of each of which are hereby incorporated by reference as if fully set forth herein. ICE is described in IETF drafts available at the time of this writing at ietf.org as draft-ietf-mmusic-sdescriptions-11.txt and draft-ietf-mmusic-ice-04.txt.

As suggested by the structures described above, perceived delays in session setup are caused as messages are exchanged among nodes to perform various functions, including routing, validation, and negotiation of terminal capabilities, among others. Some of these messages are exchanged to consult nodes that aren't required to stay in the call path, e.g. extra route/redirect/proxy servers, key distribution servers, certificate authorities, among others. Some of these messages are exchanged for all nodes in the session setup path to process the contents of the signaling message, such as the SIP INVITE message. Some of these messages are exchanged in multiple round-trip signaling transactions to setup the session, e.g. for UAS challenges of UAC for credentials, or for STUN, TURN, or ICE queries. The exchanges add processing and signaling transmission delays, as well as consuming network and end node resources.

According to some embodiments of the invention, as described in more detail below, session profiles data structures 150a, 150b (collectively referenced as session profiles 150) are stored on end nodes 120b, 120c, respectively. The information in these session profiles 150 is used to reduce session setup in subsequent sessions, as described in more detail below. In some embodiments, some or all of the session profile data structures 150 are stored on another host by a profile data server, such as a database server, or service gateway 116.

2.0 Session Profiles

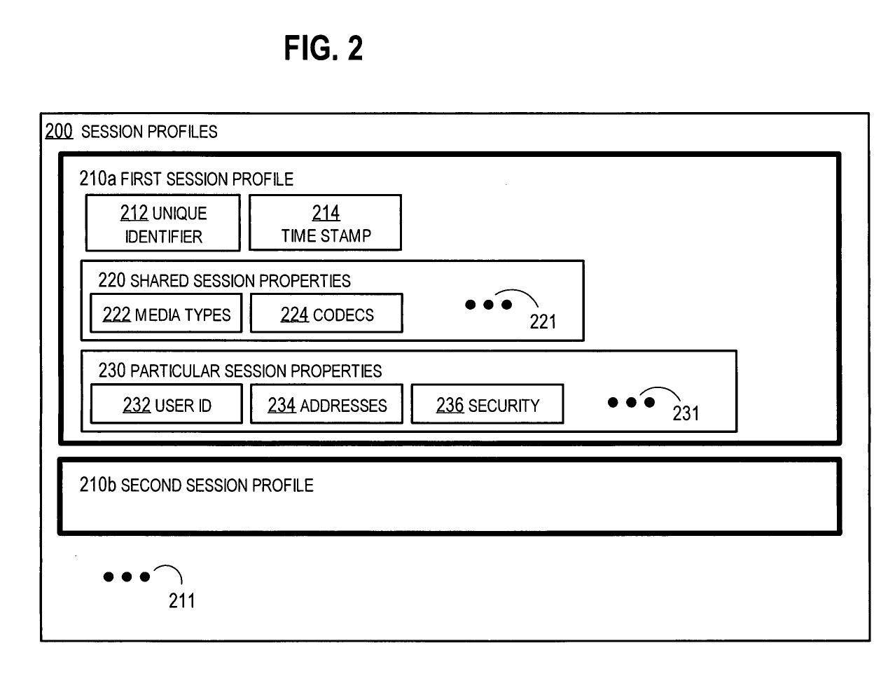

FIG. 2 is a block diagram that illustrates a session profiles data structure 200 for storing multiple session profiles, according to an embodiment. Session profiles data structure 200 (also called herein session profiles 200) includes one or more session profiles, including a first session profile 210a, second session profile 210a, and subsequent session profiles indicated by ellipsis 211, collectively referenced hereinafter as session profile 210. Although data fields are shown in a single sessions profiles data structure 200 in a certain order and grouping for purposes of illustration, in other embodiments one or more groupings or fields or portions of fields are stored in a different grouping or order or in one or more different data structures in one or more different files or databases, or changed in some combination of ways. In some embodiments, one or more portions or all of data structure 200 is stored on a separate device reachable by the end node, rather than on the end node itself.

Each session profile 210 includes a unique identifier field 212, a time stamp field 214, a set 220 of zero or more shared session properties fields, and a set 230 of one or more particular session properties fields, as depicted for the first session profile 210a. In some embodiments, the set 220 of shared session properties lists all the properties shared by end nodes in a group of end nodes, e.g., all the end nodes at a particular facility or enterprise. In some embodiments, no properties are known to be shared by a group of end nodes and the set 220 of shared session properties is omitted.

In some embodiments, a unique Negotiation Identifier (ID) for the unique identifier field 212 is calculated by the end node that initiates a negotiation for a session. The Negotiation ID is defined to uniquely identify its associated session profile. For example, in some embodiments a hash function over selected signaling elements is used to create the Negotiation ID. The end node generating the Negotiation ID signals it to the other end node as described in more detail below. In some embodiments, the contents of the unique identifier field 212 are based on a first identifier from one end node and a second identifier from the other end node.

In the illustrated embodiment, the set 220 of shared session properties fields includes media types fields 222, codecs fields 224, and zero or more additional fields indicated by ellipsis 221. The media types fields 222 indicate one or more media types supported by end nodes in the group. The codecs fields 224 indicate the type of compression used to represent the media types indicated in fields 222. Several codecs are available for media types; e.g., WAV and MP3 for recorded audio; G.711, G.723.1, and G.729 among others for session connection based audio data; JPEG, PICT, GIFF, PDF among others for image; and H.261, H.263, and H.264 (including MPEG ) among others for video. Other types of media include application specific data for such applications as collaborative documents and spreadsheets, games, and other applications. The media types and codecs are expected to be relatively uniform in an enterprise or single facility, and so the information in the set 220 of shared session properties is the same for sessions with all end nodes in the enterprise or facility.

Although the set 220 of shared session properties fields is shown stored in each session profile 210 in the session profiles 200, in other embodiments, the data in the set 220 of shared session properties fields are stored in a different file or database; and the contents of the set 220 is just a pointer to the data in the different file or database. In embodiments without shared session properties, the media types fields 222 and codecs fields 224 and other fields indicated by ellipsis 221 are included in the set 230 of particular session properties.

In the illustrated embodiment, the set 230 of particular session properties fields includes one or more user identifier (ID) fields 232, one or more logical address fields 234, one or more security fields 236, and zero or more additional fields indicated by ellipsis 231. The user ID fields 232 hold data that indicates a particular user with whom a particular session is or will be established. The logical address fields 234 hold data that indicates external or internal IP addresses and ports for the end node which the particular user operates and the remote end node, as described in more detail in the next section. The security fields 236 hold data that indicates one or more security parameters to be used in the next session with the end nodes, or used in a former session, as described in more detail in the next section.

3.0 Method to Reduce Session Setup

Reducing session setup benefits both the communicating users and the network service providers. The communicating users experience less of a delay from requesting a session until exchanging media. Network service providers benefit by employing otherwise idle resources during a pre-session period so that less compute and transmission resources are used at the time of actual session setup. This benefits the network in having a lighter workload during what is normally periods of heavy traffic. Some embodiments may use more storage resources to store the pre-session profiles; but this storage consumption is controlled, as described below. In some embodiments in which the same profiles are used by a community, such as an enterprise or a media gateway between a public, circuit switched telephone network (PSTN) and the packet switched network, storage resources would be saved because many concurrent calls leverage the very same profile.

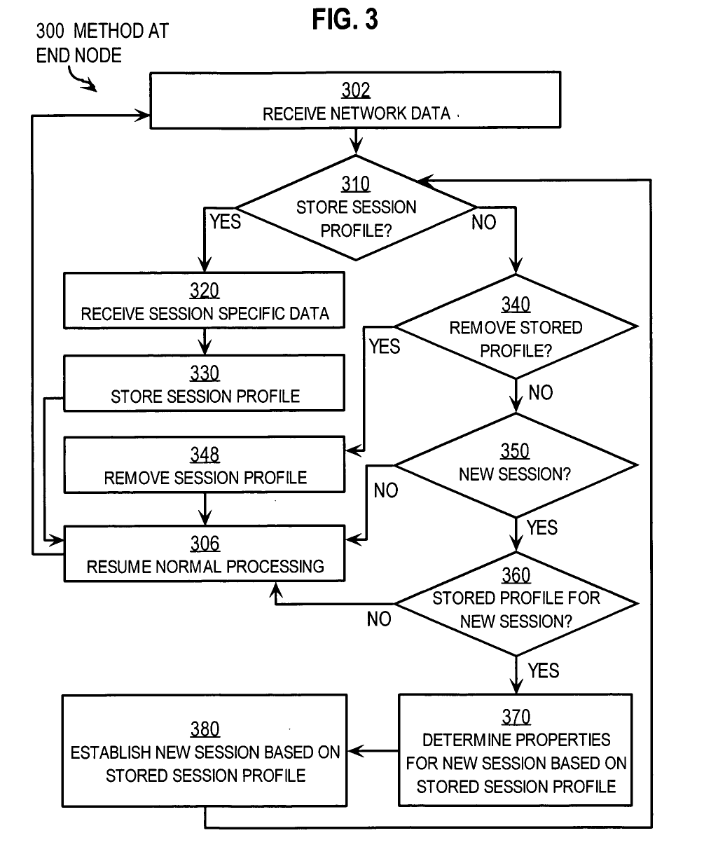

FIG. 3 is a flow diagram that illustrates at a high level a method 300 at an end node, e.g., end node 120b, for reducing session setup, e.g., for communications with end node 120c, according to an embodiment. Although steps are shown in FIG. 3 and subsequent flow diagrams in a particular order for purposes of illustration, in other embodiments one or more of the steps are performed in a different order or overlapping in time or are omitted or are changed in some combination of ways.

In step 302 network data is received at a particular end node. Network data indicates any information about network 100, including system time, congestion on any network links, routing information for forwarding data packets to ranges of IP addresses, network topology, IP or other network addresses of one or more servers and messages from such server (such as server 112, 114, 116, 118, 130), messages with times when excess network traffic should be avoided, and messages inviting the end node to a session with a remote end node. As described in more detail below, the received information is used in various embodiments to determine if a current session should be stored for future use, to determine whether values for session parameters should be negotiated ahead of time for an anticipated future session, and to determine whether the present time is appropriate for negotiating session parameters values for an anticipated future session. Any method may be used to receive the network data, including, but not limited to predefined data stored within source code or in files stored with executable code (“default values”) or in files or a database accessible to the process, human input either in response to prompts from the process or independently of prompts, or from data included in a message sent to the end node by another server or from a client process, either unsolicited or in response to a request message.

For purpose of illustration, two example embodiments are described next for method 300 executing on end node 120b for a user Alice. In the first embodiment, a current session setup already underway with end node 120c is taking more than a particular time called herein a delay threshold time (assumed to be five seconds for purposes of illustration). In a second embodiment, presence server 130 determines that a particular member (assumed to have user ID “Bob” for purposes of illustration) included in the buddy list 132a on end node 120b has become available on the network 100 behind intermediate network node 124b.

In the first example, the network data received at node 120b during step 302 is that the setup has taken so far five seconds and is not yet complete. In this case the network data includes the specific messages that have been received within a threshold time, and by implication indicates the session established message that has not yet been received. In the second example, the network data received at node 120b during step 302 is a message from presence server 130, which indicates that particular user Bob is present on the network 100.

In step 310 it is determined whether conditions are satisfied for storing a session profile. If so, control passes to step 320 to receive the session data. If not, control passes to step 340. Any conditions can be used in step 310 as a triggering mechanism to pass control to step 320 to obtain the session data. Example triggering conditions include, among others:
A. Delayed Session Setup, invoked when an end node experiences a prolonged session establishment and there is no session profile for the current remote end node, or the session profile is stale. In this case, the Session Profile is constructed, at least in part, by caching at least part of the active session's current operating setup;
B. Presence, invoked when an online end node detects the open status of a member of his buddy list and there is no session profile for that member, or the session profile is stale;
C. End Node Change, invoked by an end node that changes configuration (e.g., by moving to a different access point on the network 100) or preferences (e.g., supporting new codecs) leading to a mismatch with existing session profiles;
D. Network Changes, invoked by end node detection of network configuration changes, e.g., changes in network identities (e.g., a new SIP address), changes in route set, changes in network point of attachment, e.g. to a Session Border Controller (SBC) at edge of IP network 110a for voice data, or changes in NAT forwarding (NAT/FW) resulting in new external IP addresses, among others;
E. Stale session profiles, invoked by end node determination that a difference between the current time and the contents of the timestamp field 214 has exceeded a time to live (e.g., a persistence period described below), or exceeded a time to acquire updated session data (e.g., an updated security nonce);
F. A community of common profiles, invoked by inclusion of a user from a community call list or dialing plan (the terminating address space) which can be used to discriminate intra-community calls for calls that go outside the community (e.g., one profile to cover audio only and a second profile to cover community memebers who use video in addition to audio in their calls); and
G. A successful actual session, invoked whenever an actual session is successfully established.
   In various embodiments, the above triggering conditions are used alone or in any complementary combination. For example, if there is not a current session, conditions are satisfied for storing session data in step 310 when conditions are satisfied for negotiating values for one or more session parameters for an anticipated future session.

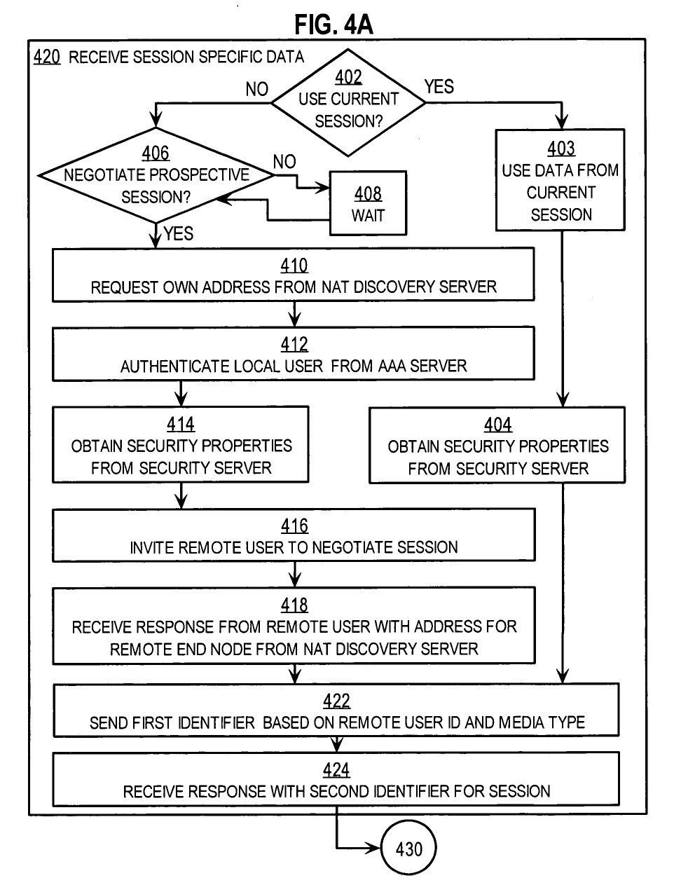

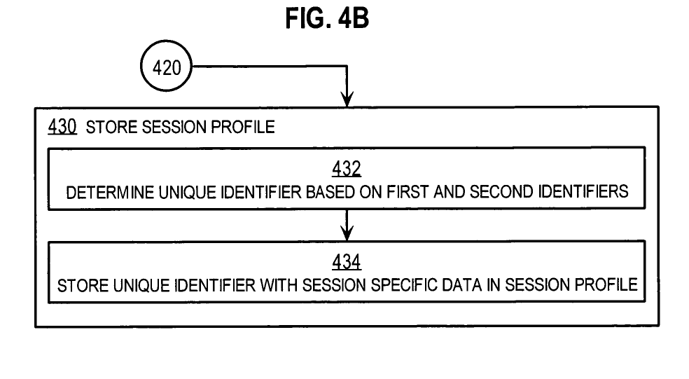

In step 320 session data for the next session is received. Either current session data is copied, such as when a delayed session is currently in progress, or a prospective session is negotiated, or some combination of these two approaches is used. For example, current values for external addresses are used, but new security parameters (e.g. nonces and keys) are negotiated. A particular embodiment of step 320 is described in more detail below with reference to FIG. 4A. Control then passes to step 330.

FIG. 4A is a flow diagram that illustrates details of step 320 of the method 300 of FIG. 3, according to an embodiment 420. Step 420 is a particular embodiment of step 320, but not the only embodiment.

In step 402, it is determined whether there are session properties of a current session to use. If so, control passes to step 403. Otherwise, control passes to step 406. For example, if the triggering condition in step 310 is a delayed session setup, then there are session properties of a current session to use, and control passes to step 403.

In step 403, session data for the current session is received from a session initiation process for storage in step 330, described below. Some of this session data might not be appropriate for the next session. For example, the nonce and session key received from a SIP Proxy acting as a security server 118 are used once; so the nonce and session key for the current session are not appropriate for the next session. Therefore control passes to step 404 to exchange messages with the SIP Proxy acting as security server 118 to obtain the nonce and session key for the next session. In embodiments that do not use encrypted sessions, step 404 is omitted. In other embodiments more or fewer negotiations take place to determine session properties for the next session.

In some embodiments, these incremental negotiations for the next session are not treated as real-time activities. In various such embodiments, these transaction activities have different protocol timers from those used in actual call setups or run at a lower priority on the given end nodes relative to user agents actively setting up calls, or both. In some such embodiments, the associated signaling is marked with a lower priority than actual session setup and control signaling.

Control then passes to steps 422 and 424 to determine and exchange a unique identifier for the session profile to use on the next session between these end nodes. Steps 422 and 424 are described in more detail below.

If it is determined in step 402 that there are not session properties of a current session to use, then control passes to step 406. In step 406, it is determined whether conditions are satisfied for negotiating a prospective future session, in order to receive the session data to store in a session profile. Any conditions may be used to determine whether to negotiate a prospective session. If conditions are not satisfied, negotiations for the prospective session are delayed to a more favorable time.

In various embodiments one or more of the following conditions are tested in step 406:
A. If central processing unit (CPU) time, memory, or other signaling resources are insufficient on the local end node;
B. If CPU time, memory, or other signaling resources are insufficient on the remote, target end node, that node may provide a failure response with a Retry-After value to indicate a better time for negotiation, thus receipt of the Retry-After value is a condition to suspend negotiations;
C. If the current time is during a network scheduled blackout (e.g., busy hour, Mother's Day, around midnight New Year's Eve, etc.) when a network administrator indicates prospective session negotiation is suspended;
D. If the current time is during a network unscheduled blackout (e.g., unpredicted busy hour or a significant national emergency) when a means to detect network congestion provides an indication for end nodes to suspend prospective session negotiations; and
E. If a random time has passed since the end node has gone online. This last condition is suggested because, when an end node goes online, another end node may simultaneously detect its online status (e.g., via a presence server 130). Without a mechanism to prevent it, each end node may simultaneous initiate the negotiation of a prospective session. Such collisions are likely to occur at certain times (e.g. beginning of the work day, right after lunch, 12 am January 1, first day after a holiday, among others). Thus, this condition is that end nodes that go online should refrain from initiating the negotiation of a prospective session for a randomly selected time interval; for instance, a wait time in seconds determined by a random selection function choosing in a range from 1 second to 1,000 seconds.
F. If a presence user advertises by way of presence status notification that it is not willing to negotiate pre-session profiles at the current time.

If it is determined in step 406 that conditions for negotiating a prospective session are not satisfied, control passes to step 408 to wait for a later time to test conditions again. Any method may be used to determine the wait interval, and the end node may perform any other processing during the wait interval. For example, in various embodiments, the wait interval is selected to equal the random time of condition E, described above; or the wait interval is selected to equal the remaining time until the end of the scheduled blackout period of condition C, described above; or the wait interval is selected to equal the Retry-After value indicated in condition B, described above; or the wait interval is selected to be indefinite, until a message is received that the network congestion has alleviated for condition D, as described above. After the wait interval, control passes back to step 406.

If it is determined in step 406 that conditions for negotiating a prospective session are satisfied, control passes to step 410 and following to negotiate the session properties for the next session.

In the illustrated embodiment, the negotiation includes steps 410, 412, 414, 416, 418, 422, 424. In other embodiments more or fewer negotiations take place to determine session properties for the next session. In some embodiments, as described above for incremental negotiations, these negotiations for a prospective session are not treated as real-time activities. In various such embodiments, these transaction activities have different protocol timers from those used in actual call setups or run at a lower priority on the given end nodes relative to user agents actively setting up calls, or both. In some such embodiments, the associated signaling is marked with a lower priority than actual session setup and control signaling.

In step 410, the local server negotiates with a NAT discovery server 114, using one or more messages, to determine the local end node's external IP address and port number for communicating with a particular external end node, e.g, the end node currently operated by Bob, or the intermediate node 124b which Bob's end node is behind.

In step 412, the local user of the local end node is authenticated in one or more messages exchanged with the AAA server 112, either directly or indirectly via the intermediate node 124, or service gateway 116, or both.

In step 414, the local end node obtains one or more security properties, including, for example, a session key and nonce, in one or more messages exchanged with security server 118 or a Proxy serving as security server 118.

In step 416, an SIP OPTIONS message is sent (e.g. to user Bob) by exchanging one or more messages with a SIP proxy (e.g. service gateway 116) to resolve the remote user's location behind an intermediate node (e.g., node 124) for a local network.

During step 418, one or more messages are exchanged between the remote end node and its NAT discovery server, and SIP proxy server, and AAA server, and the local end node so that an SIP response message can be delivered to the local end node from the remote end node.

After step 418, SIP messages can be forwarded from the local end node to the remote end node. In the illustrated embodiment, this opportunity is used to store the session setup results in session profiles on each end node for use in an actual session that has a substantial probability of occurring. To associate the stored session data in the session profiles with this prospective negotiation, one or both of the end nodes provide a value that will be used to uniquely identify the session profile in a future, reduced session setup.

Any method may be used to determine the unique identifier. In some embodiments, both end nodes use the same algorithm to deduce a unique ID based on the user IDs and this information does not need to be exchanged. In the illustrated embodiment, each end node provides an identifier that is unique for itself, and exchanges that identifier with the other end node.

For example, in step 422 the local end node sends a first identifier based on the remote user ID and the media type. This might be done, for example, because the same two end nodes can perform real-time communications in one of several modes, e.g., voice only, or voice and video, or voice and spreadsheet data, or certain games. The session properties differ for these different modes. So a different set of session data is used for the different modes.

This first identifier may be used as an index in the session profiles data structure to identify a particular profile. However, this identifier might not be unique on the remote end node, if the remote end node uses a different algorithm. Thus in the illustrated embodiment, during step 424, the local end node receives from the remote end node a second identifier that may be a unique index into the session profiles data structure on the remote end node. The two identifiers are then concatenated or hashed using the same hash function to produce a value that is unique on both end nodes, as described in more detail below.

In another embodiment, described in more detail in a later section, the end node that initiates the session negotiations provides the unique identifier (e.g., a Negotiation ID) for a new profile and the invited end node uses that unique identifier. In such embodiments, step 424 is omitted if the local end node initiates the negotiations for the prospective session; and step 422 is omitted if the remote end node initiates the negotiations for the prospective session.

In some embodiments, after values for security parameters are established at the local node in step 414 or step 404, they need to be transmitted to the remote node so it can validate them (e.g. as new certificates) and store them (e.g. as symmetric session keys) for next use. In some such embodiments, step 422 includes sending the values for one or more security parameters to the remote node; and step 424 includes receiving the values for one or more security parameters from the remote node. In some embodiments, such as in embodiments with delayed setup flow, steps 422 and 424 are combined with 416 and 418, respectively.

After step 320, an embodiment of which has been described with reference to FIG. 4A, the steps to receive the session data are complete. Control passes to step 330, depicted in FIG. 3. In step 330, session data for the next session between the same end nodes is stored in a session profile data structure, such as session profile 210 in session profiles 200.

In some embodiments, when a successful prospective session (also called a pre-session, herein) negotiation takes place between any two given end nodes, the new session profile is recorded at both end nodes, replacing a previous session profile for the same pair of end nodes, if any. However, in some embodiments, multiple profiles are useful between the same two end nodes, e.g. one for audio call, one for video call, one for games, among others. In these embodiments, the initiating end node indicates whether the pre-session negotiation is intended to replace or create a different session profile for use between the two end nodes.

A particular embodiment of step 330 is described in more detail below with reference to FIG. 4B. FIG. 4B is a flow diagram that illustrates details of a step 330 of the method 300 of FIG. 3, according to an embodiment 430. Step 430 is a particular embodiment of step 330, but not the only embodiment. Step 430 includes steps 432, 434.

In step 432, a unique identifier is determined based on the first and second identifiers exchanged in steps 422, 424, described above. For example, the two identifiers are concatenated or hashed to form a single unique identifier. In some embodiments, step 432 is omitted and the unique identifier is determined based on other data exchanged between the local and remote end nodes.

In step 434, the unique identifier is stored in association with the session data in the session profiles data structure. For example, in the illustrated embodiment, the unique identifier is stored in field 212 in the session profile for the next session using the same media between these same two end points.

After step 330 depicted in FIG. 3, an embodiment of which has been described with reference to FIG. 4B, session data appropriate at least in part for the next session using the same media types with the same remote end node are stored in a session profile, e.g., session profile 210a, in a session profiles data structure, e.g., session profiles 200.

Control passes to step 306, depicted in FIG. 3. In step 306, normal processing is resumed. For example end nodes perform processes unrelated to establishing or conducting a real-time communications session. Control then passes to step 302 to receive more network data and eventually to step 310.

If it is determined in step 310 that conditions are not satisfied for storing a session profile, control passes to step 340. In step 340, it is determined whether conditions are satisfied for removing a stored session profile, e.g., 210a, from the session profiles data structure, e.g., session profiles 200. Any conditions may be used to determine when to remove a stored session profile.

For example, it may be desirable to limit the number of concurrent stored session profiles due to resource constraints. In various embodiments, the conditions tested in step 340 include the following, among others, alone or in any combination.
A. The number of session profiles stored is limited to the number of present buddies on the end node's buddy list. In such embodiments, the number of profiles stored is necessarily limited to the number in the buddy list. In some of these embodiments, the number of cooperating present buddies is further limited to a “likely to call” subset of the buddy list indicated by a user of the end node.
B. The number of session profiles stored is limited to the last N end node users with whom communications were successfully established. In such an embodiment, the local end node is configured with the value N. In some of these embodiments, the number of last end node users with whom communications were successfully established is further limited to those on the local user's buddy list or “likely to call” subset of the buddy list.
C. Session profiles stored are limited to those that are younger than a finite persistence period, as determined by a difference between the current time and a timestamp for the stored session profile (e.g., the contents of timestamp field 214).
D. Session profiles do not survive the local node powering down, so that the session profiles data structure is clear every time the local node powers on.
E. The local user has provided, e.g., during step 302, manual input that indicates that one or more session profiles are to be removed from the session profiles data structure.
F. One or more properties of a session profile are rejected by the corresponding remote end node, e.g., when a destination endpoint rejects a proffered Negotiation ID during a session setup attempt.

If it is determined in step 340 that one or more session profiles are to be removed, then control passes to step 348. Otherwise control passes to step 350

In step 348, one or more profiles (e.g., profile 210) are removed from the session profiles data structure (e.g., session profiles 200). Any method may be used to remove a profile 210 from the session profiles 200. The profiles removed are those that cause conditions for removal to be satisfied. For example, by virtue of condition A, any remote node user who is removed from the local user's buddy list or “likely to call” buddy list is also removed from the session profiles data structure. Similarly, by virtue of condition B, any session profile with a time stamp before the N most recent sessions in the profiles data structure is removed from the session profiles data structure. By virtue of condition C, any session profile with a time stamp older than a time equal to the persistence period before the present time is removed from the session profiles data structure. By virtue of condition D, the entire contents of the session profiles data structure are cleared during powering down. By virtue of condition E, any session profile indicated by the local user's manual input is removed from the session profiles data structure.

After step 348, control passes to step 306 to perform normal processing, as described above.

In some embodiments, steps 340 and 348 are executed in a separate process running in the background on one or more CPUs on the local end node. In some embodiments, steps 340, 348 are performed during step 330 to clear space before storing a new profile. In some embodiments, there is effectively no limit imposed on the number of profiles stored (such as for a personal computer with large disk space); and steps 340, 348 are omitted.

If it is determined in step 310 that conditions are not satisfied for storing session profile, and, if present, it is determined in step 340 that conditions are not satisfied for removing a stored profile, control passes to step 350.

In step 350, it is determined whether a new session is to be established. Any method may be used to determine whether a new session is to be established. For example, for a real-time communications session initiated by the local user of the local end node (e.g., Alice at end node 120b), the local user employs a pointing device to select (e.g., “click on”) a particular member of the local user's buddy list (e.g., buddy list 132a) displayed on a display element of the local end node. For a real-time communications session initiated by a remote user of a remote end node (e.g., end node 120c), a message is received from the remote node that includes data that indicates an invitation to setup a real-time communications session.

In step 360, it is determined whether a stored profile resides in the profiles data structure for the new session to be established with the remote end node. If no stored profile is found, control passes to step 306 to do conventional processing for establishing the new session. Any method may be used to determine whether stored profile resides in the profiles data structure for a new session to be established.

For example, for a session initiated by the local user, the local end node 120 determines a first identifier based on the particular buddy list member's user ID and the type of media to be exchanged,. The first identifier is used to search for a profile (e.g., session profile 210a) in the profiles data structure (e.g., session profiles 200) that has a unique identifier (e.g., in the contents of the unique identifier field 12) based on the first identifier. If no such profile is found, control passes to step 306 to initiate a session with the remote user without benefit of the data stored in the session profiles data structures. If such a profile is found, control passes to step 370.

For a real-time communications session initiated by a remote user of a remote end node (e.g., Bob at end node 120c), a message is received from the remote node that includes a second identifier. The second identifier is used to search for a profile (e.g., session profile 210a) in the profiles data structure (e.g., session profiles 200) that has a unique identifier (e.g., in the contents of the unique identifier field 12) based on the second identifier. If no such profile is found, control passes to step 306 to complete a session with the remote user using conventional means, without benefit of the data stored in the session profiles data structures. If such a profile is found, control passes to step 370.

In step 370, at least some properties for the new session are determined based on the contents of the session profile found during step 360. For example, in some embodiments, the external IP address and port for both the local node and the remote end node are determined based on the contents of the addresses fields 234. In some embodiments, the shared secret and nonce are determined based on the contents of the security fields 236. In some embodiments, the media types and codecs are determined based on the contents of the media types fields 222 and the codecs fields 224, respectively. In some embodiments, some changes to the stored session data may have occurred since the profile was stored. In some such embodiments, an invitation message payload includes data that indicates specific changes to the existing identified session profile.

In step 380, a new session is established based on data stored session profile. For example, the Negotiation ID from the unique identifier fields 212 is signaled to the other end node in the session setup request using the SIP INVITE message. At the time of actual session setup, the Negotiation ID parameter is inserted into the session setup message and or included in other signaling messages as well, according to various embodiments. The Negotiation ID indicates that at least some signaling elements available in the stored session profile are omitted from the INVITE message. The destination remote end node uses the Negotiation ID as a key for accessing the stored session profile. If that end node agrees to use the session profile indicated by the Negotiation ID, the request is accepted and the session is quickly established.

Because the new session is established in step 380 by using one or more properties in the session profile, one or more messages with the remote end node (e.g., end node 120c) or other nodes conventionally involved during session setup (e.g., servers 112, 114, 116, 118) are omitted. For example, messages with the NAT discovery server 114 are omitted because the external IP ports and addresses are already known. Messages with the security sever 118 are omitted if the shared secret and nonce were previously negotiated and stored in the session profile. Fewer and smaller SIP messages or smaller SDP payloads, or both, are exchanged with the remote end node 120c, because the media types and codes are already known.

In some embodiments, during step 380, a proffered unique identifier is provisionally accepted provided one or more properties are updated. For example, a SIP INVITE message indicates the one or more properties to be updated and the new values. When updating session profiles, the starting point of the update negotiation is already close to the convergence point, so fewer messaging exchanges are needed to complete the profile in most embodiments.

In some embodiments, if a session attempt of a different type is made in the middle of a pre-session negotiation during step 320, the pre-session negotiation may be immediately abandoned so as not to negatively impact an actual session setup. If an endpoint requires the use of session of the type already being negotiated during step 320, the negotiation may be completed into an active session, e.g., step 330 passes control to step 380.

After step 380, control passes to step 310 to determine if conditions are satisfied for storing the session properties of the new call. For example if a few parameters where changed, the new parameters are stored in the session profile. Eventually control passes to step 306 to continue with conventional processing, e.g., to exchange the real-time communications data packets with audio and video data, such as in packets of the Real-time Protocol (RTP) or secure Real-Time Protocol (SRTP).

As a result of step 380, fewer and simpler messages are constructed and processed at the local node, and fewer RTT delays are experienced during session setup. Thus perceived delay time is reduced even if the stored profile were generated by a negotiated prospective session. If the session profile were created based on a previous session, or if the session profiles based on prospective sessions are used on average more than once per profile, then the local node and network resources to establish the sessions are also reduced overall, compared to establishing the same sessions without benefit of the data stored in the session profiles data structure. Furthermore, in embodiments that use lower priority or less busy time windows or both for incremental negotiations and negotiations for prospective sessions, the demand for high level quality of service resources and services at peak times, are also reduced.

For example, in bearer negotiation between end nodes conducted by way of the Session Description Protocol (SDP, IETF RFC-2327, RFC-3266) and H.245, bearer negotiation involves rather considerable capability parsing and may also involve multiple signaled requests and responses to derive an agreed upon negotiation. In the case of end nodes with multimedia capabilities, the bearer negotiation associated with session setup may significantly add to session setup delay. In a conferencing service, the bearer negotiation is multiplied times the number of endpoints in the conference. Using an embodiment of this invention has a multiplied beneficial effect with multimedia conferences. In the case of a SIP/SDP based call, the SDP content is minimized when the Negotiation ID is included in an INVITE request and interim (183 Session Progress) or final (200 OK) responses. Work at intermediate nodes that process SDP is also reduced because the intermediate nodes process some or even all of the SDP content at the time of the pre-session profile construction.

SIP uses various Required, Supported, Allowed, Contact-Allowed, and similar headers to probe the destination to discover what Methods, Extensions, Events, Languages, Multipurpose Internet Mail Extensions (MIME) types, or various options are supported. Caching the results of such exchanges with other endpoints in the session profiles according to some embodiments, saves the originating end node from using mechanisms or creating MIME bodies that the other side will only reject as unsupported.

For example, MIME was originally a standard for defining the types of files attached to standard Internet mail messages. The MIME standard has come to be used in many situations where one computer programs needs to communicate with another program about what kind of file is being sent. Session signaling often makes use of a MIME attachment. SIP signaling messages can carry any type of MIME body transparently through the data network. The meaning and usage of these bodies depends on the MIME types in use. Network bandwidth and end node processing is wasted if the remote end node does not understand what the local end node has sent. Learning and caching what the corresponding end node can process can improve processing efficiency and speed session setup.

SIP has an event framework, whereby event packages may be subscribed to (SUBSCRIBE method) and NOTIFY messages sent containing payloads specific to the types of events defined. One of the first such events defined was for Presence. Another example is message waiting indicator (MWI), another is dialog state events, but many new ones can also be defined. Such event packages are associated with and identified by an option tag. Part of session setup involves agreement on what event types are required, supported or optional. Learning and caching the options offered by the remote end node can preclude requiring an unsupported option leading to resubmitting setup requests and delay.

End-to-end signaling often uses Dual Tone Multi-Frequency (DTMF) tones sent from end node to end node as an emulation of the legacy telephone key pad. There are a variety of ways that those tones can be conveyed in the IP domain. For example, these tones can be conveyed as described in “RTP Payload for DTMF Digits, Telephony Tones and Telephony Signals,” RFC-2833, the entire contents of which are hereby incorporated by reference as if fully set forth herein. The end nodes agree on the methods used during session setup. Learning and caching the method used by the corresponding party can speed convergence between the end nodes.

End-to-end signaling often uses calling and called party preferences. A given party may have a single address for all of his/her communication devices at both work and home (office desk phone, home phone, cell phone, PDA, home phone mail, office phone mail, etc.). The relationship between this party and another party may be strictly business; so, pre-session setup profiles would only be negotiated with the first party's office desk phone, cell phone, and office phone mail. Support for calling and called party preferences takes additional call processing, so, in some embodiments, session setup for calls involving such preferences is accelerated by caching such preferences. In the context of SIP, calling and called party preferences are described in IETF RFC3841, the entire contents of which are hereby incorporated by reference as if fully set forth herein.

In some embodiments, properties for prospective sessions involve the reservation of resources for a given call. Ideally these resources should be successfully reserved before the called party is alerted, otherwise, the called party may “answer” a call that subsequently fails due to an unsuccessful reservation of required resources. In some embodiments, media negotiation takes resource reservation into account. For instance what media types (video, audio, and/or text) and the type of audio and/or video codecs to be employed may be a function of whether or not quality of service is available and how much high quality bandwidth may be reserved. In some embodiments, pre-session profile negotiation do not reserve resources in advance; however, those negotiations determine in advance of a real call whether or not there is the possibility to obtain such resources. The prospective session negotiation can then take into account what is and is not available. In the context of SIP, such resource preconditions are described in IETF RFC3312, the entire contents of which are hereby incorporated by reference as if fully set forth herein.

Security mechanisms often take advantage of current secure communication channels to exchange further information. According to some embodiments of the invention, the success of current session security can be leveraged to convey keys, nonces, initialization vectors, and algorithms to be used in future security associations for subsequent sessions. Activities like Kerberos ticket retrieval or X.509 certificate validation do not need to be repeated. In such embodiments, it is preferred that session profile persistence periods do not exceed the certificate expiration date, as mentioned above. In some embodiments, Certificate Revocation List (CRL) checks are performed periodically during the life of a session profile and also after session setup to remove a session profile or terminate a session when a certificate is revoked.

STUN, TURN, and ICE involve a complicated series of probing with corresponding NAT discovery servers that enable an end node to discover if it is behind a NAT or series of NATs and to discover which IP addresses and ports are private or reachable from the wide area IP network, such as the public Internet. The planned use of NATs at various network to network interfaces (NNIs) between service providers (SP) may mean that these NAT discovery procedures have to be repeated to get to different end nodes, depending on which SPs are involved. In some embodiments, due to network modifications, the local end node periodically renegotiates prospective sessions to determine how the local end node can be reached and to refresh bindings in network servers. The information learned from these probing activities is cached and used at session setup time rather than delaying setup while new probes are launched.

In most cases, the records for Domain Name Servers (DNS) and ENUM do not change very often. ENUM is a system to use DNS to relate E.164 numbers to universal resource locators (URLs) used on the public Internet; where E.164 is the International Telecommunication Union (ITU) standard identifying telephone number formats. It is also likely that in the future most of these entries will also be electronically signed. The validation of such signatures requires time and processing power. In some embodiments, the results of previous queries are cached in session profiles and used to save the round trip time (RTT) and processing delays for fresh DNS/ENUM queries. In some alternative embodiments, stored hashes of queries in session profiles are used to confirm that no changes occurred and thus the current results can be used without exchanging and processing the traffic for rechecking the signature.

It has been observed that SDP processing by some gateways has occasionally become excessive primarily because a minimum of 5 codecs, and often in excess of 12 codecs, were being offered. The SDP messages were much larger, sometimes doubling the size, because of the extra codecs. The SDP was carried not only in SIP but also in MGCP. This affected both the bandwidth being used per call and the amount of time spent processing each message. This affected the call per second throughput by as much as an order of magnitude, depending on what resource limits were encountered on the gateways. Furthermore, the SIP/SDP message size was approaching the point where fragmentation is needed. It can be expected that adding video and other media types will only exacerbate this SDP effect. According to some embodiments, incremental and prospective negotiations narrow the codec down to the exact voice, video, instant messaging (IM), or other media type known to have worked in the past, through caching this information and associating the information with a remote node in one or more session profiles. In such embodiments:
the media lines are 1 per media type (not 12 times per media type);
the likelihood of fragmentation is reduced;
processing load per call is reduced;
bandwidth for both device control and call control connections is reduced; and
calls per second (CPS) increases.
   These benefits are in addition to the reduction of call setup delay.

### 4.0 EXAMPLE DETAILED EMBODIMENTS

More complete example embodiments of the invention are illustrated in this section. An example session setup using conventional processes is first described to serve as a basis of comparison to indicate the reduction of setup according to the illustrated embodiments. After two embodiments are described in which session profiles are stored, an embodiment is described that uses the cached session profiles to reduce session startup traffic and delays.

For clarity in the illustrated example, a single service with two modes is negotiated. In other embodiments, multiple services are possible, with each service having dozens of modalities. The local user, Alice, intends to have a multimedia session involving audio and two separate videos with the remote user, Bob. As part of the session setup negotiation, Bob's answer to Alice's offer states support for only one video type. Both a Proxy and Bob challenge Alice to authenticate herself. Each end node is behind a single non-symmetric NAT, with properties discoverable using a STUN server as NAT discovery server 114.

The session's media will be secured by way of the Secure Real-Time Transport Protocol (SRTP) described in RFC3711; SDP offer/answer negotiations derive agreed upon SRTP security parameters. For both Alice and Bob, PKI certificates are exchanged. The processing of such certificates involve some signaling to PKI infrastructure to fetch additional certificates to link the trusted roots together and to search for Certificate Revocation Lists to verify that the certificates are still valid. Finally, cryptographic processes are used to check each certificate in the chain to validate the chain of trust. Alternatively, in shared secret systems such as KERBEROS, Key Distribution Servers (KDS) are accessed to generate tickets. A secret shared by end nodes A and B is doubly encrypted first as a ticket for B, then as a token for A, which is then given to A, which relays it to B. Accessing the KDS can be done in advance so the ticket is ready to transmit immediately with the next INVITE. In the session flow example below, certificates are exchanged as a body part in the SIP messaging.

In summary the sample session establishment illustrates media negotiation, NAT resolution, proxy challenge to authentication, user agent challenge to authentication, SRTP security parameter negotiation, and security certificate exchanges.

4.1 Conventional Session Setup

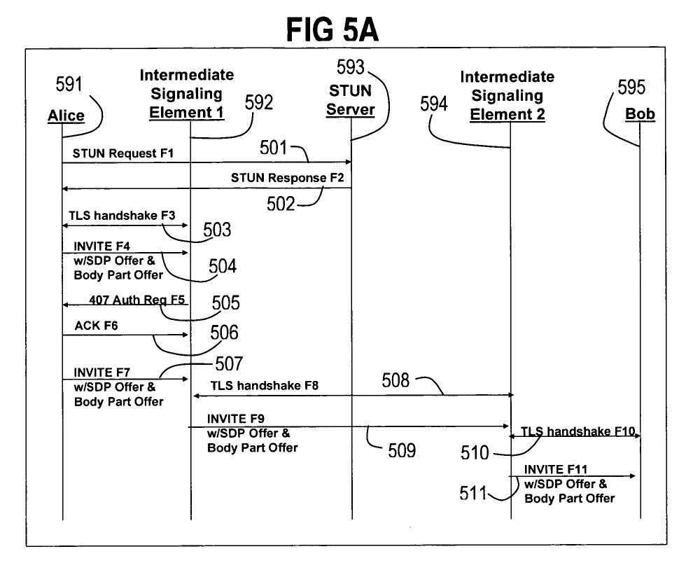

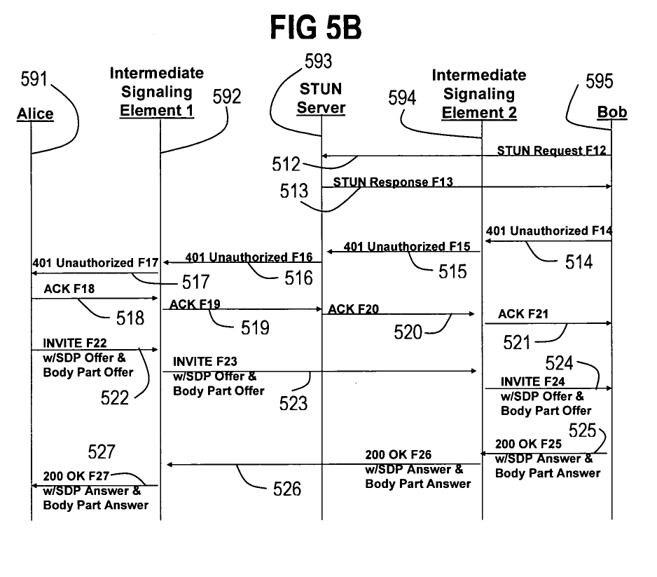

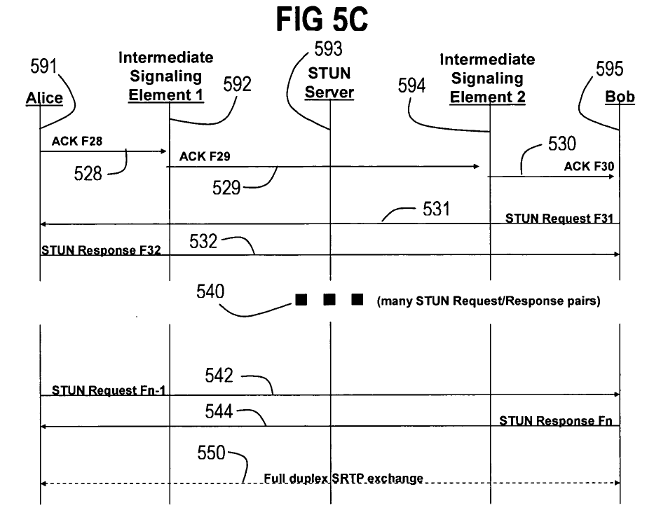

FIG. 5A, FIG. 5B, FIG. 5C are sequential time sequence diagrams that illustrate the example network traffic to set up a real-time communication session using conventional methods. Time increases downward in each FIG. and increases from FIG. 5A to FIG. 5B to FIG. 5C. A network node that sends, receives or passes a message is represented by a vertical bar. Messages exchanged between network nodes are represented by horizontal arrows, with arrowheads indicating the direction of propagation. End node 591, designated Alice (e.g., end node 120b), initiates the session. Intermediate network node 592, designated intermediate signaling element 1, authenticates Alice, routes the session message towards its ultimate destination, and executes network policies. For example, finctions of intermediate network node 592 are performed by a SIP Proxy server (e.g., either gateway server 116 or a SIP Proxy server on another host). Intermediate node 124a with the NAT process is not shown as it is not involved with the SIP exchange. It covertly modifies the IP addresses and ports of message traffic that passes through, but does not modify the SIP messages to correspond, i.e. it is not an application layer gateway (ALG). STUN server 593 performs the functions of NAT discovery server 114. End node 595, designated Bob (e.g., end node 120c), is the target remote end node for the session. Intermediate network node 594, designated signaling element 2, performs session setup functions over the wide area IP network for Bob.

The session setup traffic consists of the messages or message exchanges 501 through 532, 540, 542, and 544. Real-time communications using the negotiated properties are exchanged in message eexchagne 550.

Message 501 is a STUN BINDING REQUEST. In this message, Alice queries a STUN server. This query originally contains her local IP address and is modified by her NAT (e.g., NAT 125a), which replaces her local internal IP address with a public external IP address and port for Alice. The message is forwarded to the STUN server 593. Message 502 is a STUN BINDING RESPONSE. The STUN server returns Alice's external IP address and port. The receiving NAT (e.g., NAT 125a) appends Alice's external IP address and port with her internal address and port, and passes this response on to Alice's end node 591.

Message 503 represents an exchange of Transport Layer Security (TLS) messages, by which the TLS handshake secures the signaling path on this hop between Alice and the SIP Proxy server. The transport layer is carried in an IP payload.

Message 504 is an SIP INVITE message with an SDP payload (body part). The properties offered in the SDP payload include a couple of media types and codecs and proposed encryption properties. For example, an offer for a bidirectional audio stream and two bidirectional video streams, using H.261 (payload type 31) and MPEG (payload type 32) and information in support of Secure RTP would include the following attributes.
v=0
o=alice 2890844526 2890844526 IN IP4 host.anywhere.com
s=Codec & Encryption Discussion
c=IN IP4 host.anywhere.com
t=0 0
m=audio 49170 RTP/SA VP 0
a=rtpmap:0 PCMU/8000
a=crypto:1 AES_CM_{—}128_HMAC_SHA1_{—}80
inline:WVNfX19zZW1jdGwgKCkgewkyMjA7fQp9CnVubGVz|2ˆ20|1:4
FEC_ORDER=FEC_SRTP
a=crypto:2 F8_{—}128_HMAC_SHA1_{—}80
inline:MTIzNDU2Nzg5QUJDREUwMTIzDU2Nzg5QUJjZGVm|2ˆ20|1:4
FEC_ORDER=FEC_SRTP
m=video 51372 RTP/SA VP 31
a=rtpmap:31 H261/90000
a=crypto:1 AES_CM_{—}128_HMAC_SHA1_{—}80
inline:VWOgY28yYV2ieFVhIDiffvlzNkB8gRq8BMWubFWa|2ˆ20|1:4
FEC_ORDER=FEC_SRTP
a=crypto:2 F8_{—}128_HMAC_SHA1_{—}80
inline:MCIzNUD3Mzh9HJKLGFDwMCIzDU2Nxf5QUIjZGV|2ˆ20|1:4
FEC_ORDER=FEC_SRTP
m=video 53000 RTP/SA VP 32
a=rtpmap:32 MPV/90000
a=crypto:1 AES_CM_{—}128_HMAC_SHA1_{—}80
inline:ABCeB19aAC9kdHwfQKcgiwkiOpZ0fOe0DpWebVVz|2ˆ20|1:4
FEC_ORDER=FEC_SRTP
a=crypto:2 F8_{—}128_HMAC_SHA1_{—}80
inline:TUBzBUT2Nzz5PQOWIEUvNSUzDK3Mzz4QQQjABWt|2ˆ20|1:4
FEC_ORDER=FEC_SRTP

Message 505 is an SIP 407 message that indicates authentication is required. The SIP Proxy has challenged Alice to authenticate herself using security properties that can be used to verify Alice's identity. In an illustrated example, this message includes the following attributes.
realm=“forAlice.voiceserviceprovider.com”
nonce=“f84f1cec41e6cbe5aea9c8e88d359”
algorithm=MD5.

Message 506 is a SIP acknowledgement (ACK) message. Alice acknowledges the SIP Proxy's request for authentication.

Message 507 is a signed SIP INVITE message. This invite includes the SDP payload of message 504 but also includes a response that only Alice can produce and that the Proxy server 592 can verify. For example, this message includes the following additional header attributes that authenticate Alice's end node to her Proxy server 592.
realm=“forAlice.voiceserviceprovider.com”
nonce=“f84f1cec41e6cbe5aea9c8e88d359”
response=“42ce3cef44b22f50c6a6071bc8”.
   This message is accepted by the SIP Proxy as authentically from Alice and is forwarded to the SIP Proxy for Bob.

Message exchanges 508 include TLS messages that perform a TLS handshake to secure the signaling traffic on this hop between SIP Proxy servers. Message 509 forwards the SIP INVITE message 507 from Alice to the SIP Proxy for Bob on signaling element 2, intermediate node 594. Message exchanges 510 include TLS messages that perform a TLS handshake to secure the signaling traffic on this hop between Bob's SIP Proxy server and Bob's end node 595. Message 511 forwards the SIP INVITE message 509 (originally message 507 from Alice) at Bob's Proxy server, intermediate node 594, from Bob's Proxy server to Bob's end node 595.

As shown in FIG. 5B, message 512 is a STUN BINDING REQUEST from Bob's end node 595 to the STUN server 593. This message queries a STUN server with a query that contains the internal IP address for Bob's end node; and Bob's NAT (e.g., NAT 125b) replaces it with an external IP address and port for Bob. Message 513 is a STUN BINDING RESPONSE. The STUN server returns Bob's external address. The receiving NAT appends Bob's external address with his internal address and passes this response on to Bob's end node 595

Messages 514 through 517 are SIP 401 UNAUTHORIZED messages, as propagated from Bob's end node 595 to Bob's SIP Proxy server 594 to STUN server 593 to Alice's SIP Proxy server 592 to Alice's end node 591. By this UNAUTHORIZED message, Bob's end node 595 requests Alice's end node 591 to authenticate herself to him. For example, this UNAUTHORIZED message includes the following attributes to be used by Alice to authenticate herself to Bob.
realm=“realm.example.com”
nonce=“olvn98gh48nUipw89-923wKJC”
algorithm=MD5

Messages 518 through 521 are SIP ACK messages, as propagated from Alice's end node 591 to Alice's SIP Proxy server 592 to STUN server 593 to Bob's SIP Proxy server 594 to Bob's end node 595. By this ACK message, Alice's end node 591 acknowledges Bob's end node 595 request for authentication. Messages 522 through 524 are SIP INVITE messages, as propagated from Alice's end node 591 to Alice's SIP Proxy server 592 to Bob's SIP Proxy server 594 to Bob's end node 595. Note that the STUN server 593 is not used for this message. This INVITE message includes the SDP payload of message 507 but also includes a second response that only Alice's end node can produce for Bob's end node. For example, this message includes the following additional header attributes that authenticate Alice's end node to Bob's end node.
realm=“realm.example.com”
nonce=“oIvn98gh48nUipw89-923wKJC”
response=“kldrJ32023iun30u438065VA40849tyZs”.

Messages 525 through 527 are SIP 200 OK messages, as propagated from Bob's end node 595 to Bob's SIP Proxy server 594 to Alice's SIP Proxy server 592 to Alice's end node 591. Note that the STUN server 593 is not used for this message. This OK message contains Bob's end node's SDP Answer and an Encrypted Application/Profile Body Part containing security. The SDP Answer also contains agreed Secure RTP cryptology parameters. The SDP Answer also indicates that Bob's end node does support the first video stream. For example, the SDP Answer contains the following.
v=0
o=bob 2890844730 2890844730 IN IP4 host.example.com
s=−
c=IN IP4 host.example.com
t=0 0
m=audio 49920 RTP/AVP 0
a=rtpmap:0 PCMU/8000
a=crypto:1 AES_CM_{—}128_HMAC_SHA1_{—}80
inline:PS1uQCVeeCFCanVmcjkpPywjNWhcYD0mXXtxaVBR|2ˆ20|1:4
m=video 0 RTP/AVP 31
m=video 53000 RTP/AVP 32
a=rtpmap:32 MPV/90000
a=crypto:1 AES_CM_{—}128_HMAC_SHA1_{—}80
inline:1ORvRBWffCFKanCMvkjpPjvyNoWaCZX0m00txaCSC|2ˆ20|1:4

As shown in FIG. 5C, messages 528 to 530 are SIP ACK messages that acknowledge the SIP 200 OK message from Bob's end node, as propagated from Alice's end node 591 to Alice's SIP Proxy server 592 to Bob's SIP Proxy server 594 to Bob's end node 595.

Messages 531, 532 and subsequent messages indicated by ellipsis 540, and messages 542, 544 are multiple STUN BINDING REQUESTs and the corresponding STUN BINDING RESPONSEs to establish external IP addresses and ports for various protocols used by the end nodes for real-time communications of various media. Both Alice's and Bob's end nodes perform STUN connectivity checks involving many STUN REQUEST/RESPONSE pairs. Each internal local address is paired up with each candidate external address advertised by the peer end node. A check is successful if it elicits a response. A STUN check may lead Bob's or Alice's end node to learn a new address of the peer. If this happens, Bob's or Alice's end node will perform checks for this new address too. Given that this example involves two media streams in combination with a single non-symmetric NAT in front of each end node, each end node would issue 5 STUN REQUESTs (1 for the received signaling, and, for each received media stream, 1 for RTP and 1 for RTCP). All checks from either end node proceed in parallel.

Message exchange 550 is a full duplex exchange of SRTP messages that carry the two-way real-time audio and video communications between Alice's end node and Bob's end node.

FIG. 5A, 5B, 5C indicate that a large amount of message traffic is involved during setup of sessions for real-time communications. This large traffic consumes end node resources, network resources, and is perceived as excessive delay by the users of the end nodes, e.g., Alice and Bob. Absent an embodiment of the present invention, the same traffic illustrated in FIG. 5A, 5B, 5C is involved to create a subsequent session between Alice's and Bob's end nodes.

According to some embodiments, data from traffic similar to that depicted in FIG. 5A, 5B, 5C is stored as session profiles (e.g., profile 210) in a session profiles data structure (e.g., session profiles 200) to save either end node and network resources, or perceived delay, or both.

4.2 Session Profile Triggered by Excessive Delay

In this embodiment, a session, such as that described above, has already been established and is still in progress. In some embodiments Alice determines (e.g., during step 402) from evaluating the time from her sending of the INVITE until receiving the 200 OK from Bob that this session took too long to establish, e.g., it exceeds the delay threshold time. In some embodiments Alice is prompted during step 402; and in some embodiments the determination is made automatically. Control passes to step 403, during which the session properties of the successful current session are received. While this session is still in progress, Alice's end node determines a unique Negotiation ID, e.g., the first identifier, and sends it to Bob's end node. For purposes of illustration, it is assumed that the unique Negotiation ID value is 6626MiN34eRgSec. During step 404, Alice's end node refreshes the authentication parameters and security certificates for a future session. During step 422, Alice's end node sends to Bob's end node a SIP OPTIONS message which includes the attribute “Negotiation ID=6626MiN34eRgSec” and an attached Encrypted Application/Profile Body Part with the refreshed authentication and security properties. The presence of the Negotiation ID triggers the recording at Bob's end node of the successful session's negotiated properties and the refreshed authentication and security properties as a session profile at Bob's end node. Bob's 200 OK response, received during step 424, includes an Encrypted Application/Profile Body Part also refreshing authentication parameters for a future session with Alice. In some embodiments, intermediate node 592 inserts for its own benefit into the 200 OK its own Body Part for refreshing authentication parameters for signing the future INVITE. In some embodiments, the OPTIONS request also contains an SDP offer with new cryptology parameters for the future set of SRTP media streams.

During step 430, the session data is stored as a session profile 210 at Alice's end node. The NAT translations and selected media for this existing session are stored with the new security properties for use in a subsequent session between Alice and Bob for as long as this session profile remains valid.

4.3 Session Profile Triggered by Presence

In this embodiment, Alice's presence application (e.g., server 130) is notified that Bob has become active. The Presence Server 130 includes in its initial NOTIFY to Alice's end node 120b, the presence server's realm and authentication nonce. The NOTIFY message is received by Alice's end node during step 302. The inclusion of the realm and authentication nonce is an implied authentication request made to Alice regarding future transactions. The nonce is refreshed from time to time in future NOTIFYs. In this way, Alice can send signed requests to the first signaling entity right up front, thereby improving overall processing efficiency.

Bob is listed in the set of buddies (e.g., buddy list 132a) designated for prospective session setup (also called pre-session setup). There may be additional buddies who may be designated by Alice for pre-session setup, but to keep things simple in this illustration only the participants Alice and Bob are considered. Alice's presence application sends to Alice's end node a NOTIFY message when Bob comes online and indicates his presence to the presence server 130. This NOTIFY message constitutes more network data received during step 302. Up to this point, the network traffic is traffic that would be performed anyway for Alice to receive presence data about Bob, such as for an Instant Messenger (IM) service. Thus these steps do not count as cost for using the illustrated embodiment. In some embodiments in which Alice otherwise would not use a presence server, these steps do count as cost for doing the prospective negotiation.

Based on this NOTIFY message, Alice's end node determines in step 310 to store a session profile for real-time communications with Bob.

Control flows to step 320 to receive the session data. In step 320, it is determined in step 402 that there is not a current session to use, so control passes to step 406 to determine whether conditions are satisfied for negotiating a prospective session. It is assumed for purposes of illustration that, after waiting a random number of seconds to avoid collisions with Bob, no conditions for suspending such pre-session setup apply, so control passes to step 410 and following steps.

For example, during step 410, Alice's end node sends a STUN Binding Request and receives a STUN Binding Response, as described above. During step 416, Alice's end node makes a SIP SDP offer and an Encrypted Application/Profile Body Part Offer as part of a negotiation for a prospective session with Bob. The SIP SDP offer is already signed by way of the previously provided realm and nonce effectively authenticating Alice to the Intermediate Signaling Element 1. As in the original session illustration, the SDP describes media and media encryption parameters while the Encrypted Application/Profile Body Part refreshes the authentication parameters and security certificates for a future session. The SIP OPTIONS message includes the header attribute NegotiationID=6626MiN34eRgSec as step 422 overlaps step 416 in this embodiment. The presence of the NegotiationID header in this message indicates to Bob's end node that the negotiated session properties are to be cached for use in subsequent sessions. In some embodiments, the realm and nonce for the SIP digest authentication to be used in signing the future INVITE is provided in the Body Part Offer from Alice's end node. In some embodiments, Bob's end node provides realm and nonce for the SIP digest authentication in his Body Part Answer. Note that the SIP OPTIONS request is already signed by Alice's end node to authenticate herself to the Intermediate Signaling Element 1 using the authentication parameters provided by the previous SIP NOTIFY message from the presence server.

After some STUN message exchanges by Bob's end node and the STUN server, and Bob's end node request for authentication of Alice's end node, as described above, Bob's end node responds positively to Alice and includes both his SDP and Encrypted Application/Profile Body Part Answer. At both user agents, this successful negotiation is associated with (also termed “bounded to”) the Negotiation ID sent by Alice.

In step 330, Alice's end node stores the session properties obtained during this prospective session setup.

It is noted that at Bob's end node, the SIP SDP OPTIONS message is the network data received during step 302. If the SDP OPTIONS message includes a NegotiationID header, then it is determined in step 310 to store a session profile. Control passes to step 320 to receive the session data for the profile during message exchange with Alice's end node and other servers. Control then passes to step 330 to store the session data as a session profile in a session profiles data structure, such as session profiles 200.

In summary this simple pre-session negotiation creation example shows how media stream choices, NAT resolution, authentication, SRTP cryptology parameters, and security certificate exchanges may be negotiated for a prospective session in advance of an actual session.

4.4 Reduced Setup Using Session Profile

In this embodiment, Alice's end node sends to Bob's end node an SIP INVITE with neither a SDP offer nor an Encrypted Application/Profile Body Part offer. The SIP OPTIONS header includes the NegotiationID=6626MiN34eRgSec, which implies the SDP and Encrypted Application/Profile Body Part content in both directions. Bob's end node does not request authentication from Alice since the need for authentication and the parameters in support of such authentication were already previously addressed; the INVITE is already signed. Session setup occurs quickly.

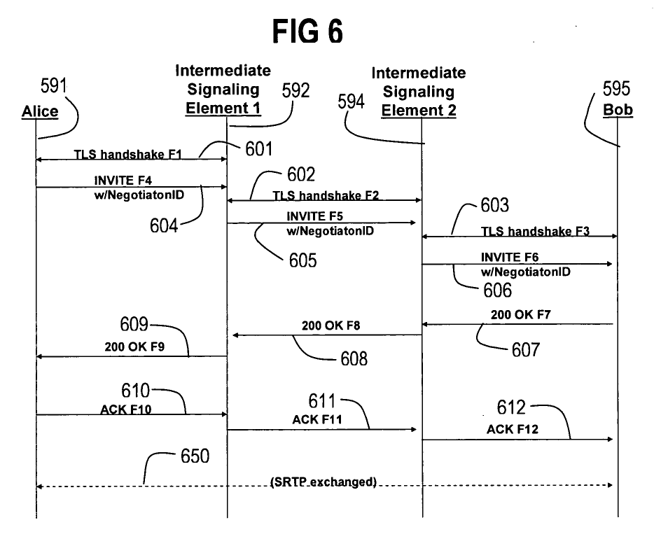

FIG. 6 is a time sequence diagram that illustrates example network traffic to set up an actual real-time communication session according to an embodiment using a stored session profile. Time increases downward; and a network node that sends, receives or passes a message is represented by a vertical bar. Messages exchanged between network nodes are represented by horizontal arrows, with arrowheads indicating the direction of propagation. End node 591, designated Alice (e.g., end node 120b), initiates the session. Intermediate network node 592, designated signaling element 1, initiates sessions over the wide area IP network for Alice. For example, functions of intermediate network node 592 are performed by a SIP Proxy server (e.g., either gateway server 116 or a SIP Proxy server). End node 595, designated Bob (e.g., end node 120c), is the target remote end node for the session. Intermediate network node 594, designated signaling element 2, performs session setup functions over the wide area IP network for Bob. Note that STUN server 593 involved in FIG. 5A, 5B and 5C is not included in FIG. 6.

The reduced session setup traffic consists of the messages or message exchanges 601 through 612. Real-time communications of negotiated properties are exchanged in messages 650. Compare the 12 message exchanges in FIG. 6 to the over 40 message exchanges in FIG. 5A, 5B, 5C. STUN messages are entirely absent. Also note the significantly reduced content for some of these 12 messages as well. Much of the negotiation processing was previously completed. Clearly, setup is reduced in this embodiment, both in terms of processing load at time of setup and in terms of perceived delay.

Messages 601 to 603 are TLS messages that perform the TLS handshake to secure the signaling paths on all the three hops from Alice's end node 591 to her intermediate node 592 to Bob's intermediate node 594 to Bob's end node 595.

Messages 604 to 606 are SIP INVITE messages that are already signed by Alice's end node and which contain a NegotiationID=6626MiN34eRgSec instead of the SDP and Encrypted Application/Profile Body part. These fewer and much smaller messages take fewer network resources, such as bandwidth, to transmit. They also consume less CPU processing cycles at the time of actual session setup.

Messages 607 to 609 are SIP 200 OK messages in which Bob's end node accepts the INVITE and agrees to use the session profile associated with NegotiationID=6626MiN34eRgSec.

Messages 610 to 612 are SIP ACK messages in which Alice acknowledges the SIP 200 OK response.

Message exchange 650 is a full duplex exchange of SRTP messages that carry the two-way real-time audio and video communications between Alice's end node and Bob's end node.

As stated above, it is clear from comparing FIG. 6 with FIG. 5A and FIG. 5B and FIG. 5C that setup is substantially reduced in the embodiment of FIG. 6, both in terms of processing load at time of setup and in terms of perceived delay.

5.0 Implementation Mechanisms—Hardware Overview

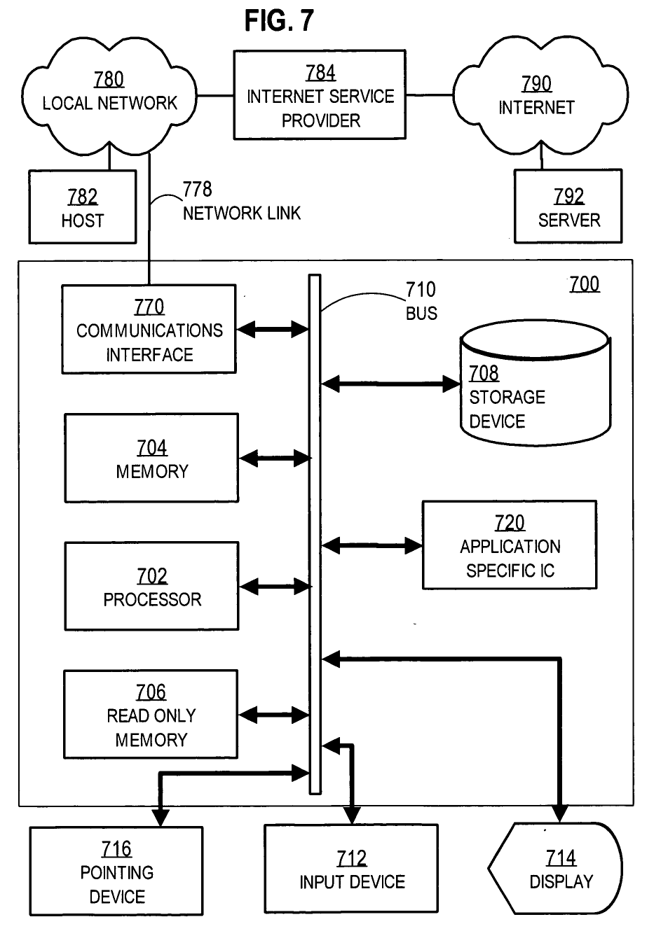

FIG. 7 is a block diagram that illustrates a computer system 700 upon which an embodiment of the invention may be implemented. Computer system 700 includes a communication mechanism such as a bus 710 for passing information between other internal and external components of the computer system 700. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit). A sequence of binary digits constitutes digital data that is used to represent a number or code for a character. A bus 710 includes many parallel conductors of information so that information is transferred quickly among devices coupled to the bus 710. One or more processors 702 for processing information are coupled with the bus 710. A processor 702 performs a set of operations on information. The set of operations include bringing information in from the bus 710 and placing information on the bus 710. The set of operations also typically include comparing two or more units of information, shifting positions of units of information, and combining two or more units of information, such as by addition or multiplication. A sequence of operations to be executed by the processor 702 constitute computer instructions.

Computer system 700 also includes a memory 704 coupled to bus 710. The memory 704, such as a random access memory (RAM) or other dynamic storage device, stores information including computer instructions. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of computer instructions. The computer system 700 also includes a read only memory (ROM) 706 or other static storage device coupled to the bus 710 for storing static information, including instructions, that is not changed by the computer system 700. Also coupled to bus 710 is a non-volatile (persistent) storage device 708, such as a magnetic disk or optical disk, for storing information, including instructions, that persists even when the computer system 700 is turned off or otherwise loses power.

Information, including instructions, is provided to the bus 710 for use by the processor from an external input device 712, such as a keyboard containing alphanumeric keys operated by a human user, or a sensor. A sensor detects conditions in its vicinity and transforms those detections into signals compatible with the signals used to represent information in computer system 700. Other external devices coupled to bus 710, used primarily for interacting with humans, include a display device 714, such as a cathode ray tube (CRT) or a liquid crystal display (LCD), for presenting images, and a pointing device 716, such as a mouse or a trackball or cursor direction keys, for controlling a position of a small cursor image presented on the display 714 and issuing commands associated with graphical elements presented on the display 714.

In the illustrated embodiment, special purpose hardware, such as an application specific integrated circuit (IC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends and receives electrical, acoustic or electromagnetic signals, including infrared and optical signals, that carry information streams, such as digital data. Such signals are examples of carrier waves.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and waves that travel through space without wires or cables, such as acoustic waves and electromagnetic waves, including radio, optical and infrared waves. Signals that are transmitted over transmission media are herein called carrier waves.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read.

Network link 778 typically provides information communication through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790. A computer called a server 792 connected to the Internet provides a service in response to information received over the Internet. For example, server 792 provides information representing video data for presentation at display 714.

The invention is related to the use of computer system 700 for implementing the techniques described herein. According to one embodiment of the invention, those techniques are performed by computer system 700 in response to processor 702 executing one or more sequences of one or more instructions contained in memory 704. Such instructions, also called software and program code, may be read into memory 704 from another computer-readable medium such as storage device 708. Execution of the sequences of instructions contained in memory 704 causes processor 702 to perform the method steps described herein. In alternative embodiments, hardware, such as application specific integrated circuit 720, may be used in place of or in combination with software to implement the invention. Thus, embodiments of the invention are not limited to any specific combination of hardware and software.

The signals transmitted over network link 778 and other networks through communications interface 770, which carry information to and from computer system 700, are exemplary forms of carrier waves. Computer system 700 can send and receive information, including program code, through the networks 780, 790 among others, through network link 778 and communications interface 770. In an example using the Internet 790, a server 792 transmits program code for a particular application, requested by a message sent from computer 700, through Internet 790, ISP equipment 784, local network 780 and communications interface 770. The received code may be executed by processor 702 as it is received, or may be stored in storage device 708 or other non-volatile storage for later execution, or both. In this manner, computer system 700 may obtain application program code in the form of a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to an infra-red signal, a carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

6.0 Extensions and Alternatives

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for reducing session set up for real-time communications over a network, comprising the steps of:
receiving at a local end node session specific data that indicates multiple properties of a first session for real-time communications between the local end node and a remote end node connected to a network;
determining at the local end node whether conditions are satisfied for storing the session specific data; and
if it is determined that conditions are satisfied for storing the session specific data, then:
storing the session specific data;
after storing the session specific data, determining at the local end node whether a second session is to be established between the local end node and the remote end node; and
if it is determined that the second session is to be established, then
determining at the local end node multiple properties of the second session based on the session specific data, and
establishing the second session using the multiple properties of the second session instead of additional traffic over the network to negotiate the multiple properties of the second session.

2. A method as recited in claim 1 wherein the multiple properties include at least one of:
a communication media type supported at the remote end node, selected from a plurality of media types that include voice, video, instant message, text message, application data for each application of a set of one or more applications, and any combination of media types;
a security attribute for a session with the remote end node; and
a quality of network service required for a session with the remote end node using the communication media type.

3. A method as recited in claim 1 wherein the multiple properties include at least one of:
calling party preference data that indicates at least one of a device and network address for a calling party who initiates the second session;
called party preference data that indicates at least one of a device and network address for a calling party who is an invitee to the second session; and
preconditions data that indicates a network resource that should be available to support the second session.

4. A method as recited in claim 1 wherein the multiple properties include at least one of:
firewall transversal data that indicates how to establish the second session with the remote end node behind a firewall process that blocks some network traffic;
NAT traversal data that indicates how to establish the second session with a remote end node when a network address translation (NAT) process operates between the local end node and the remote end node; and
name resolution data that indicates a network address of the remote end node based on a name associated with the remote end node, such as provided by a domain name server (DNS) or an ENUM server.

5. A method as recited in claim 4, said step of receiving session specific data further comprising receiving the name resolution data from one of:
a domain name server (DNS); and
an ENUM server.

6. A method as recited in claim 1 wherein the multiple properties include at least one of:
a MIME type data that indicates a Multipurpose Internet Mail Extensions (MIME) type supported by the remote end node;
event type data that indicates a type of event that sends a notify message which event is supported by the remote end node;
DTMF type data that indicates a method for transporting Dual Tone Multi-Frequency (DTMF) tones during the second session; and
protocol options data that indicates options for a session setup protocol used during the second session.

7. A method as recited in claim 6 wherein the protocol options data that indicates options for a session setup protocol indicates for the Session Initiation Protocol (SIP) at least one of:
an Allow message type;
a Require protocol option; and
a Supported protocol option.

8. A method as recited in claim 1, wherein said step of storing the session specific data further comprises determining a unique identifier for real-time communications with the remote end node, and
storing the unique identifier in association with the session specific data; and
said step of establishing the second session further comprises communicating with the remote end node a message that includes the unique identifier.

9. A method as recited in claim 8, said step of determining a unique identifier for the remote end node further comprising determining a unique identifier for the remote end node and a first media type for real-time communication between the local end node and the remote end node.

10. A method as recited in claim 1, wherein:
said step of determining whether conditions are satisfied for storing the session specific data further comprises determining that a remote user of a particular plurality of remote users is present on the network;
said step of receiving session specific data further comprises exchanging network traffic to determine the multiple properties of the first session for real-time communications with the remote end node where the remote user is present, whereby the first session is a prospective session; and
said step of determining whether a second session is to be established further comprises receiving data that indicates an actual session with the remote user is being established, whereby the second session is an actual session.

11. A method as recited in claim 10, said step of exchanging network traffic to determine the multiple properties of the first session further comprising exchanging network traffic at a lower priority than traffic to establish an actual session.

12. A method as recited in claim 10, wherein
said step of storing the session specific data further comprises
determining a unique identifier for real-time communications with the remote end node, and
storing the unique identifier in association with the session specific data; and
said step of establishing the second session further comprises communicating with the remote end node a message that includes the unique identifier.

13. A method as recited in claim 12, said step of exchanging network traffic to determine the multiple properties of the first session further comprising communicating with the remote end node a message that includes the unique identifier.

14. A method as recited in claim 10, said step of exchanging network traffic for the prospective session further comprising:
determining whether conditions are satisfied for exchanging network traffic for the prospective session; and
if it is determined that conditions are not satisfied for exchanging network traffic for the prospective session, then suspending said step of exchanging network traffic for the prospective session.

15. A method as recited in claim 14, wherein conditions for exchanging network traffic include at least one of:
sufficient resources at local end node for exchanging network traffic for the prospective session;
sufficient resources at remote end node for exchanging network traffic for the prospective session; and
sufficient resources on network for exchanging network traffic for the prospective session.

16. A method as recited in claim 14, wherein conditions for exchanging network traffic include at least one of:
a random time has expired since the local end node has begun communications over the network, to avoid collisions with network traffic for prospective sessions initiated by other network end nodes; and
the current time is not within a predetermined blackout period when prospective sessions are barred by network policy.

17. A method as recited in claim 1, wherein:
the first session is an actual session established between the local end node and the remote end node;
the second session is different from and subsequent to the first session; and
said step of receiving session specific data further comprises receiving data that indicates multiple properties already negotiated for the first session for real-time communications with the remote end node.

18. A method as recited in claim 17, said step of determining whether conditions are satisfied for storing the session specific data further comprises determining that a session start time between requesting the first session and beginning real-time communications exceeds a threshold time.

19. A method as recited in claim 17, wherein
said step of storing the session specific data further comprises
determining a unique identifier for real-time communications with the remote end node, and
storing the unique identifier in association with the session specific data; and
said step of establishing the second session further comprises communicating with the remote end node a message that includes the unique identifier.

20. A method as recited in claim 19, further comprising the step of communicating with the remote end node a message that includes the unique identifier.

21. A method as recited in claim 1, further comprising:
determining whether conditions are satisfied for deleting the session specific data from storage; and
if it is determined that conditions are satisfied for deleting the session specific data from storage, then deleting the session specific data from storage.

22. A method as recited in claim 21, wherein conditions for deleting the session specific data include at least one of:
a number of different, more recent sessions with stored session specific data equals a particular maximum number of different sessions; and
a time when the session specific data was stored exceeds a particular age.

23. A method as recited in claim 21, wherein conditions for deleting the session specific data include at least one of:
a remote user associated with the remote end node in the session data is not present on the network;
the remote user is removed from a plurality of remote users for whom session data is stored; and
the remote user is no longer associated with the remote end node.

24. A method as recited in claim 21, wherein conditions for deleting the session specific data include at least one of:
the remote end node refuses any of the multiple properties of the second session; and
the local end node that was connected to the network at a particular access point for the stored session specific data is now connected to the network at a different access point.

25. A method as recited in claim 1, said step of receiving session specific data further comprising receiving shared session data that indicates one or more properties for real-time communications between the local end node and any end node of a plurality of remote end nodes.

26. An apparatus for reducing session set up for real-time communications over a network, comprising:
means for receiving at a local end node session specific data that indicates multiple properties of a first session for real-time communications between the local end node and a remote end node connected to a network;
means for determining at the local end node whether conditions are satisfied for storing the session specific data;
means for storing the session specific data and determining at the local end node whether a second session is to be established, if it is determined that conditions are satisfied for storing the session specific data;
means for determining at the local end node multiple properties of the second session based on the session specific data and establishing the second session between the local end node and the remote end node using the multiple properties of the second session instead of additional traffic over the network to negotiate the multiple properties of the second session, if it is determined that the second session is to be established.

27. An apparatus for reducing session set up for real-time communications over a network, comprising:
a network interface that is coupled to a network for communicating one or more packet flows therewith;
one or more processors;
a computer-readable medium; and
one or more sequences of instructions held by the computer-readable medium which instructions, when executed by the one or more processors, causes the one or more processors to carry out the steps of:
receiving session specific data that indicates multiple properties of a first session for real-time communications between the apparatus and a remote end node connected to a network;
determining whether conditions are satisfied for storing the session specific data; and
if it is determined that conditions are satisfied for storing the session specific data, then:
storing the session specific data;
after storing the session specific data, determining whether a second session is to be established between the apparatus and the remote end node; and
if it is determined that the second session is to be established, then
determining multiple properties of the second session based on the session specific data, and
establishing the second session using the multiple properties of the second session instead of additional traffic over the network to negotiate the multiple properties of the second session.

28. An apparatus as recited in claim 27 wherein the multiple properties include at least one of:
a communication media type supported at the remote end node, selected from a plurality of media types that include voice, video, instant message, text message, application data for each application of a set of one or more applications, and any combination of media types;
a security attribute for a session with the remote end node; and
a quality of network service required for a session with the remote end node using the communication media type.

29. An apparatus as recited in claim 27 wherein the multiple properties include at least one of:
calling party preference data that indicates at least one of a device and network address for a calling party who initiates the second session;
called party preference data that indicates at least one of a device and network address for a calling party who is an invitee to the second session; and
preconditions data that indicates a network resource that should be available to support the second session.

30. An apparatus as recited in claim 27 wherein the multiple properties include at least one of:
firewall transversal data that indicates how to establish the second session with the remote end node behind a firewall process that blocks some network traffic;
NAT traversal data that indicates how to establish the second session with a remote end node when a network address translation (NAT) process operates between the local end node and the remote end node; and
name resolution data that indicates a network address of the remote end node based on a name associated with the remote end node, such as provided by a domain name server (DNS) or an ENUM server.

31. An apparatus as recited in claim 30, said step of receiving session specific data further comprising receiving the name resolution data from one of:
a domain name server (DNS); and
an ENUM server.

32. An apparatus as recited in claim 27 wherein the multiple properties include at least one of:
a MIME type data that indicates a Multipurpose Internet Mail Extensions (MIME) type supported by the remote end node;
event type data that indicates a type of event that sends a notify message which event is supported by the remote end node;
DTMF type data that indicates a method for transporting Dual Tone Multi-Frequency (DTMF) tones during the second session; and
protocol options data that indicates options for a session setup protocol used during the second session.

33. An apparatus as recited in claim 32 wherein the protocol options data that indicates options for a session setup protocol indicates for the Session Initiation Protocol (SIP) at least one of:
an Allow message type;
a Require protocol option; and
a Supported protocol option.

34. An apparatus as recited in claim 27, wherein
said step of storing the session specific data further comprises
determining a unique identifier for real-time communications with the remote end node, and
storing the unique identifier in association with the session specific data; and
said step of establishing the second session further comprises communicating with the remote end node a message that includes the unique identifier.

35. An apparatus as recited in claim 34, said step of determining a unique identifier for the remote end node further comprising determining a unique identifier for the remote end node and a first media type for real-time communication between the apparatus and the remote end node.

36. An apparatus as recited in claim 27, wherein:
said step of determining whether conditions are satisfied for storing the session specific data further comprises determining that a remote user of a particular plurality of remote users is present on the network;
said step of receiving session specific data further comprises exchanging network traffic to determine the multiple properties of the first session for real-time communications with the remote end node where the remote user is present, whereby the first session is a prospective session; and
said step of determining whether a second session is to be established further comprises receiving data that indicates an actual session with the remote user is being established, whereby the second session is an actual session.

37. A method as recited in claim 36, said step of exchanging network traffic to determine the multiple properties of the first session further comprising exchanging network traffic at a lower priority than traffic to establish an actual session.

38. An apparatus as recited in claim 36, wherein
said step of storing the session specific data further comprises
determining a unique identifier for real-time communications with the remote end node, and
storing the unique identifier in association with the session specific data; and
said step of establishing the second session further comprises communicating with the remote end node a message that includes the unique identifier.

39. An apparatus as recited in claim 38, said step of exchanging network traffic to determine the multiple properties of the first session further comprising communicating with the remote end node a message that includes the unique identifier.

40. An apparatus as recited in claim 36, said step of exchanging network traffic for the prospective session further comprising:
determining whether conditions are satisfied for exchanging network traffic for the prospective session; and
if it is determined that conditions are not satisfied for exchanging network traffic for the prospective session, then suspending said step of exchanging network traffic for the prospective session.

41. An apparatus as recited in claim 40, wherein conditions for exchanging network traffic include at least one of:
sufficient resources at the apparatus for exchanging network traffic for the prospective session;
sufficient resources at remote end node for exchanging network traffic for the prospective session; and
sufficient resources on network for exchanging network traffic for the prospective session.

42. An apparatus as recited in claim 40, wherein conditions for exchanging network traffic include at least one of:
a random time has expired since the apparatus has begun communications over the network, to avoid collisions with network traffic for prospective sessions initiated by other network end nodes; and
the current time is not within a predetermined blackout period when prospective sessions are barred by network policy.

43. An apparatus as recited in claim 27, wherein:
the first session is an actual session established between the apparatus and the remote end node;
the second session is different from and subsequent to the first session; and
said step of receiving session specific data further comprises receiving data that indicates multiple properties already negotiated for the first session for real-time communications with the remote end node.

44. An apparatus as recited in claim 43, said step of determining whether conditions are satisfied for storing the session specific data further comprises determining that a session start time between requesting the first session and beginning real-time communications exceeds a threshold time.

45. An apparatus as recited in claim 43, wherein
said step of storing the session specific data further comprises
determining a unique identifier for real-time communications with the remote end node, and
storing the unique identifier in association with the session specific data; and
said step of establishing the second session further comprises communicating with the remote end node a message that includes the unique identifier.

46. An apparatus as recited in claim 45, said one or more sequences of instructions further causing the one or more processors to carry out the step of communicating with the remote end node a message that includes the unique identifier.

47. An apparatus as recited in claim 27, said one or more sequences of instructions further causing the one or more processors to carry out the steps of:
determining whether conditions are satisfied for deleting the session specific data from storage;
if it is determined that conditions are satisfied for deleting the session specific data from storage, then deleting the session specific data from storage.

48. An apparatus as recited in claim 47, wherein conditions for deleting the session specific data include at least one of:
a number of different, more recent sessions with stored session specific data equals a particular maximum number of different sessions; and
a time when the session specific data was stored exceeds a particular age.

49. An apparatus as recited in claim 47, wherein conditions for deleting the session specific data include at least one of:
a remote user associated with the remote end node in the session data is not present on the network;
the remote user is removed from a plurality of remote users for whom session data is stored; and
the remote user is no longer associated with the remote end node.

50. An apparatus as recited in claim 47, wherein conditions for deleting the session specific data include at least one of:
the remote end node refuses any of the multiple properties of the second session; and
the apparatus that was connected to the network at a particular access point for the stored session specific data is now connected to the network at a different access point.

51. An apparatus as recited in claim 27, said step of receiving session specific data further comprising receiving shared session data that indicates one or more properties for real-time communications between the apparatus and any end node of a plurality of remote end nodes.

52. A computer-readable medium carrying one or more sequences of instructions for reducing session set up for real-time communications over a network, wherein execution of the one or more sequences of instructions by one or more processors causes the one or more processors to perform the steps of:
receiving session specific data that indicates multiple properties of a first session for real-time communications between a processor of the one or more processors and a remote end node connected to a network;
determining whether conditions are satisfied for storing the session specific data; and
if it is determined that conditions are satisfied for storing the session specific data, then:
storing the session specific data;
after storing the session specific data, determining whether a second session is to be established between the processor and the remote end node; and
if it is determined that the second session is to be established, then
determining multiple properties of the second session based on the session specific data, and
establishing the second session using the multiple properties of the second session instead of additional traffic over the network to negotiate the multiple properties of the second session.
